(19) United States
(12) Patent Application Publication
(10) Pub. No.: US 2026/0209530 A1
(43) Pub. Date: Jul. 23, 2026

(54) VANADIUM COMPLEXES WITH NITROGEN AND OXYGEN DONOR ATOMS

(71) Applicant: Borchers GmbH, Langenfeld (DE)

(72) Inventors: Neil John Simpson, Bearsden (GB); Martin Klussmann, Langenfeld (DE); Steffen Brand, Hilden North Rhine-Westphalia (DE); Percia Arockiam, Langenfeld (DE)

(73) Assignee: Borchers GmbH, Langenfeld (DE)

(21) Appl. No.: 19/138,507

(22) PCT Filed: Dec. 15, 2023
(86) PCT No.: PCT/EP2023/086005

§ 371 Date: Jun. 12, 2025

(30) Foreign Application Priority Data
Dec. 16, 2022 (EP) 22214080.8

(51) Int. Cl. C09D 7/63; C09D 167/06

(52) U.S. Cl. CPC C09D 7/63; C09D 167/06

(57) ABSTRACT

The invention pertains generally to metal complexes of vanadium, iron, manganese or copper with ligands which contain at least one nitrogen and at least one oxygen donor atom, e.g., non-symmetrical amino acids and Schiff-base ligands.

### CROSS-REFERENCE TO RELATED APPLICATIONS

This application is a national stage application, filed under 35 U.S.C. § 371, of International Patent Application No. PCT/EP2023/086005 filed on Dec. 15, 2023, which claims the benefit of and priority to European patent application number EP22214080.8 filed on Dec. 16, 2022, the disclosures of each of which are hereby incorporated by reference in their entirety.

### TECHNICAL FIELD

The invention described herein pertains generally to metal complexes with ligands which contain at least one nitrogen and at least one oxygen donor atom, e.g., amino acids and phenolic Schiff bases, the combination illustrating an improvement of at least one physical property selected from the group consisting of improved coating hardness, reduced coating peeling and reduced dry time.

### BACKGROUND OF THE INVENTION

Primary paint driers, typically metal carboxylates like cobalt neodecanoate, are used to catalyse the oxidative drying (curing) of alkyd resins. Generally, these driers are complexes based on transition metals. Cobalt driers are the most used drying catalysts as they result in highly cross-linked and hard films. Highly cross-linked and hard films are desirable because they have higher scratch, chemical and corrosion resistance. However, several environmental studies have suggested potential reclassification of cobalt-based alkyd driers. Borchi® Oxy Coat (“BOC”), is a primary drier for alkyds. It has been found that BOC shows faster curing and less yellowing of alkyd films at much lower concentrations than cobalt. However, BOC when compared to some cobalt driers, has been found lacking in the formation of hard films

Therefore, there is a need for non-cobalt-based driers as alternatives. The lack of hardness impacts the use of BOC as a cobalt replacement in more demanding applications, such as direct to metal coatings or decorative coatings, to allow scratch resistance, improved corrosion resistance and the ability to stack painted pieces quickly.

Driers, based on vanadyl sulfonates, generally give higher hardness in coatings as compared with BOC. However, the rate of curing is often slower than compared to BOC and the desired hardness of the coatings is often reached after an undesirably long time. In addition, these driers showed poor coating after water immersion, compared with BOC and cobalt-based driers, which is an important test in some fields of general industrial coatings.

In the aerobic curing of alkyds, various vanadium complexes have been used as primary driers. Vanadyl acetylacetonate (VO(acac)₂) is known as a drier but was generally not regarded as having outstanding performance. Recently, the groups of Vinklárek and Honzíček at the University of Pardubice, Czech Republic have developed several vanadium-carboxylate, acetylacetonate-derivatives and dithiocarbamates driers, for example, and tested them in mostly solvent-borne alkyds. In comparison with cobalt-based driers, these performed generally good at often lower loadings than cobalt, but also at generally higher loadings than is common for BOC.

Several patents describe vanadium-based driers for the curing of alkyds. For example, one mentions a photoinitiator together with a V-drier, (see WO 2007/017032 A1); one describes the curing of special hybrid alkyd acrylates with a variety of driers including vanadium, (see US2010/0160551 A1); one the specific use of α-hydroxy carboxylates of various metals as driers, including vanadium, (see WO 2016/154205 A1); one the combination of cerium and vanadium carboxylates (see CN 108165083 A). The curing of resins with vanadium-based driers together with added peroxides as oxidants is also described in some patents, including one from Akzo Nobel that uses polymer-bound driers (see U.S. Pat. No. 9,751,994 B2) and one from Sherwin Williams using various metal-based driers (see US 2010/0160551 A1). Two Borchers patents describe vanadium phosphates and vanadyl dicarboxylates, acetylacetonates and related ligands (see EP 0870811 A2; and U.S. Pat. No. 6,063,841 A).

The use of vanadium complexes bearing organic ligands have been described in very various fields of chemistry. Tables I, II and III illustrate general and specific structures of ligands used in vanadium complexes for other applications. An important feature in the context of the present invention is that sometimes chelating ligands bearing at least one oxygen donor atom and one nitrogen donor atom are used (henceforth abbreviated L_{O,N} ligands) and where the chelating ligand has at least two oxygen donor atoms and one nitrogen donor atom are used are abbreviated as L_{ONO} ligands (see Table I). The depictions with the curved bond between the N and O atoms are illustrative of bridging groups as discussed herein, and the interposed N and O atoms coordinatively bonded to a metal atom.

TABLE I

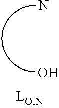

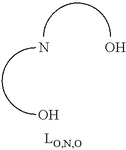

As used in this patent application, the general structures of ligands used in vanadium driers wherein the ligands have two bridging nitrogen atoms and two oxygen atoms are defined herein as L_{O,N,N,O}, while ligands bearing two to four nitrogen atoms are defined herein as L_{N,N}, L_{N,N,N} and L_{N,N,N,N} and ligands bearing only one oxygen atom are defined herein as (L_{O}). Examples of those ligands are shown in Table II below.

TABLE II

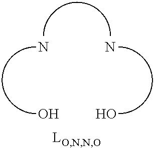

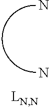

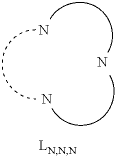

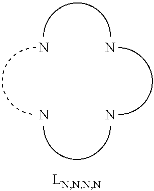

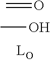

WO 2003/029371 A1 mentions a mix or a variety of metal-based primary driers, including vanadium, together with specific symmetric Schiff-base ligands of the L_{O,N,N,O} or salen type bearing solubilizing groups. The general structure of a salen ligand is shown in Table III, including one of the ligands specified in this patent (the so-called Jacobsen's ligand XJ).

TABLE III

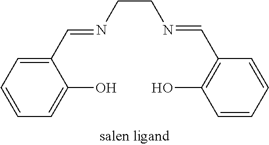 [SMILES: Oc1ccccc1/C=N/CC/N=C/c1ccccc1O]

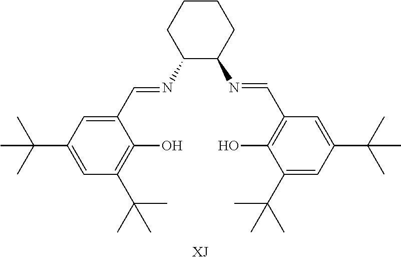 [SMILES: CC(C)(C)c1cc(/C=N/[C@@H]2CCCC[C@H]2/N=C/c2cc(C(C)(C)C)cc(C(C)(C)C)c2O)c(O)c(C(C)(C)C)c1]

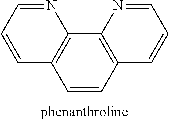 [SMILES: c1cnc2c(c1)ccc1cccnc12]

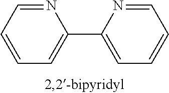 [SMILES: c1ccc(-c2ccccn2)nc1]

(C₈H₁₇)₃P═O
XC

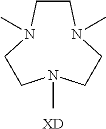

Patents EP 0304149 B1 and U.S. Pat. No. 5,154,764 A employ vanadium salts as driers or additives which can be combined with “chelating agents” of type L_{N,N} and L_{O}, of which specifically 1,10-phenanthroline, 2,2′-bipyridyl and tri-n-octylphosphine oxide (XC) are mentioned (Table III). Patent EP 1696010 B1 also mentions the possibility of adding bipyridyl to a vanadium compound for the curing of alkyds. Patent WO 2001/046294 A1 mentions the possibility to add 1,10-phenanthroline and 2,2′-bipyridyl in the same context.

Patent WO2015/082553 A1 also mentions the curing of alkyds with iron-based driers including the addition of vanadium carboxylates together with L_{N,N} and L_{N,N,N} ligands like 2,2′-bipyridyl, phenanthroline, 1,4,7-tri-azacyclononanyl (XD) or various simple amines as well as porphyrins (type L_{N,N,N,N}). Nitrogen donor ligands in general are mentioned in WO 2021/009079 A1 in the context of alkyd curing which may involve vanadium-based driers. The ligands are not further specified, except that they only contain nitrogen as donor atoms. Similarly, purely nitrogen-donor ligands are also mentioned in WO 2014/122432 A1, WO 2014/122433 A1, and WO 2014/122434 A1 as potential additives to the curing of alkyds involving metal carboxylates which include vanadium.

In addition to the application of vanadium complexes in the aerobic curing of alkyds (or the curing of composites in the presence of added peroxides), vanadium complexes bearing organic ligands have been described in very different fields. These include, for example, fundamental spectroscopic studies, oxidation reactions of small molecules like alcohols and sulfides, and the use as biologically active compounds.

A specific L_{O,N} ligand is 8-hydroxyquinoline, bearing a phenolic OH and an imine-like nitrogen atom (8HQ, see Table IV), which has been used as a ligand for vanadium-complexes in numerous occasions, but has not been shown to have been used for alkyd curing (drying). Similarly, L_{O,N} Schiff-base ligands of a non-symmetrical type derived of salicylaldehyde bear a phenolic OH group in the vicinity of the imine. These ligands are sometimes also called “half-salen” ligands and are shown as structure HS in Table IV. A class of those half-salen ligands are of the type L_{O,N,O}, derived from amino acids as the amine-component, shown as structure HS-AA in Table IV.

TABLE IV

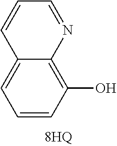 [SMILES: Oc1cccc2cccnc12]

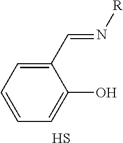

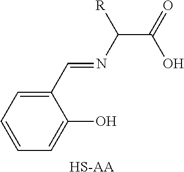

Schiff-base ligands like HS-His (See Table V) are made from the corresponding amino acid and salicylaldehyde, and have been described in the literature, but not for the purpose of alkyd curing (drying). Vanadium-complexes bearing Schiff-base ligands synthesized from amino acids, including for example ligand HS-His can be synthesized in a one-pot procedure from vanadyl sulfate, the corresponding amino acid and salicylaldehyde. The same way of synthesis was also described for the complex with ligand HS-Trp.

TABLE V

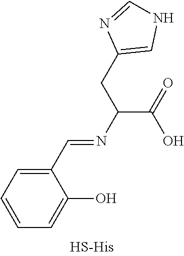 [SMILES: O=C(O)C(Cc1c[nH]cn1)/N=C/c1ccccc1O]

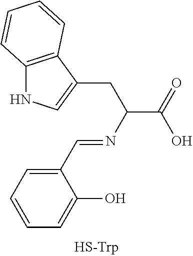 [SMILES: O=C(O)C(Cc1c[nH]c2ccccc12)/N=C/c1ccccc1O]

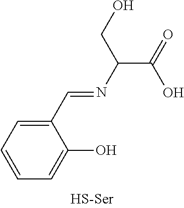 [SMILES: O=C(O)C(CO)/N=C/c1ccccc1O]

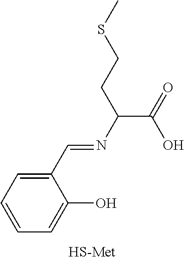 [SMILES: CSCCC(/N=C/c1ccccc1O)C(=O)O]

HS-His: 2-((2-hydroxybenzylidene)amino)-3-(1H-imidazol-4-yl)propanoic acid
HS-Trp: 2-((2-hydroxybenzylidene)amino)-3-(1H-indol-3-yl)propanoic acid
HS-Ser: 3-hydroxy-2-((2-hydroxybenzylidene)amino)propanoic acid
HS-Met: 2-((2-hydroxybenzylidene)amino)-4-(methylthio)butanoic acid

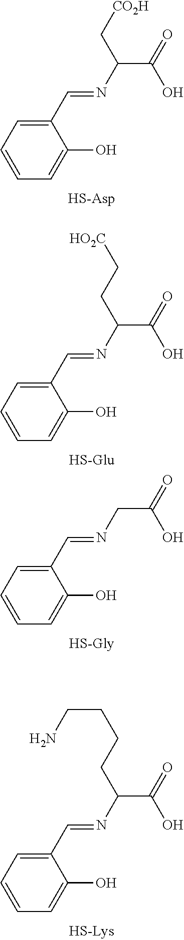 [SMILES: O=C(O)CC(/N=C/c1ccccc1O)C(=O)O ; O=C(O)CCC(/N=C/c1ccccc1O)C(=O)O ; O=C(O)C/N=C/c1ccccc1O ; NCCCCC(/N=C/c1ccccc1O)C(=O)O]

HS-Asp: 2-((2-hydroxybenzylidene)amino)succinic acid
HS-Glu: 2-((2-hydroxybenzylidene)amino)pentanedioic acid
HS-Gly: 2-((2-hydroxybenzylidene)amino)acetic acid
HS-Lys: 6-amino-2-((2-hydroxybenzylidene)amino)hexanoic acid

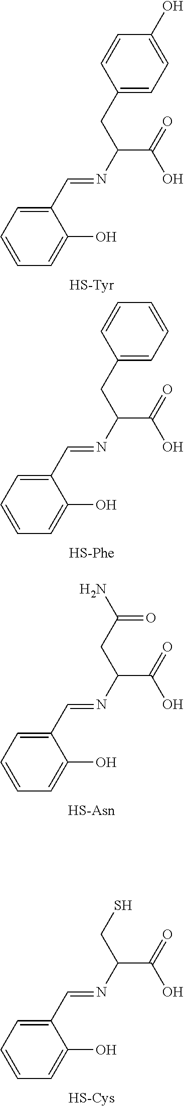 [SMILES: O=C(O)C(Cc1ccc(O)cc1)/N=C/c1ccccc1O ; O=C(O)C(Cc1ccccc1)/N=C/c1ccccc1O ; NC(=O)CC(/N=C/c1ccccc1O)C(=O)O ; O=C(O)C(CS)/N=C/c1ccccc1O]

HS-Tyr: 2-((2-hydroxybenzylidene)amino)-3-(4-hydroxyphenyl)propanoic acid
HS-Phe: 2-((2-hydroxybenzylidene)amino)-3-phenylpropanoic acid
HS-Asn: 4-amino-2-((2-hydroxybenzylidene)amino)-4-oxobutanoic acid
HS-Cys: 2-((2-hydroxybenzylidene)amino)-3-mercaptopropanoic acid

TABLE V

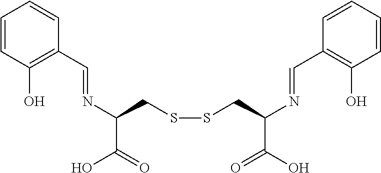 [SMILES: O=C(O)[C@H](CSSC[C@@H](/N=C/c1ccccc1O)C(=O)O)/N=C/c1ccccc1O]

HS-Cysteine

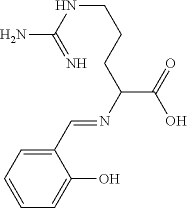 [SMILES: N=C(N)NCCCC(/N=C/c1ccccc1O)C(=O)O]

HS-Arg

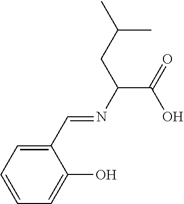 [SMILES: CC(C)CC(/N=C/c1ccccc1O)C(=O)O]

HS-Leu

HS-Cystine: 3-((2-carboxy-2-((2-hydroxybenzylidene)amino)ethyl)disulfaneyl)-2-((2-hydroxybenzylidene)amino)propanoic acid
HS-Arg: 5-guanidino-2-((2-hydroxybenzylidene)amino)pentanoic acid
HS-Leu: 2-((2-hydroxybenzylidene)amino)-4-methylpentanoic acid

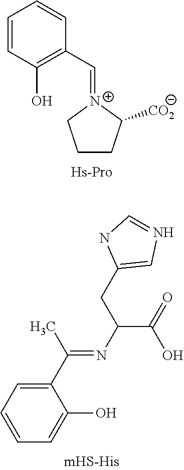

HS-Pro: 1-(2-hydroxybenzylidene)pyrrolidin-1-ium-2-carboxylate
mHS-His: 2-((1-(2-hydroxyphenyl)ethylidene)amino)-3-(1H-imidazol-4-yl)propanoic acid

The synthesis and characterization of HS-Gly, HS-Ala, HS-Val, HS-Leu, HS-Ile, HS-Met, HS-Phe, HS-Thr, HS-Asp and HS-His is described in Inorganica Chimica Acta 293 (1999) 1-11, “Preparation and Characterisation of New Oxovanadium (IV) Schiff Base Complexes derived from Amino Acids and Aromatic o-Hydroxyaldehydes” by Pessoa, Cavaco, Correia, Duarte, Gillard, Henriques, Higes, Madeira and Tomaz.

Without being held to any one theory of operation or mode of application, it is believed that ligands of the type ImP would be capable of performing the functions of the ligands above as illustrated in Table VI.

TABLE VI

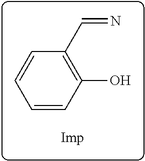

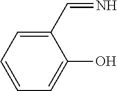

3117-61-1

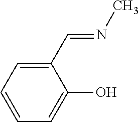

3117-65-5

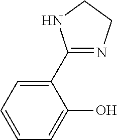 [SMILES: Oc1ccccc1C1=NCCN1]

1565-39-5

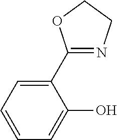 [SMILES: Oc1ccccc1C1=NCCO1]

20237-92-7

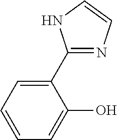 [SMILES: Oc1ccccc1-c1ncc[nH]1]

52755-90-5

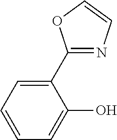 [SMILES: Oc1ccccc1-c1ncco1]

109604-76-4

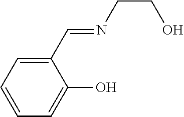 [SMILES: OCC/N=C/c1ccccc1O]

1962-38-1

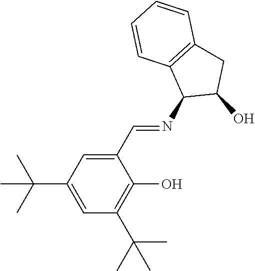 [SMILES: CC(C)(C)c1cc(/C=N/[C@H]2c3ccccc3C[C@H]2O)c(O)c(C(C)(C)C)c1]

212378-89-7

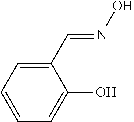

94-67-7

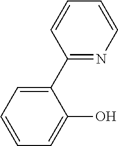 [SMILES: Oc1ccccc1-c1ccccn1]

33421-36-2

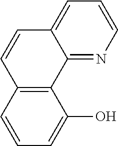 [SMILES: Oc1cccc2ccc3cccnc3c12]

33156-90-7

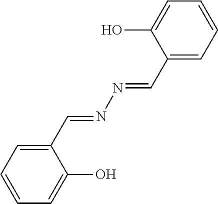 [SMILES: Oc1ccccc1/C=N/N=C/c1ccccc1O]

959-36-4

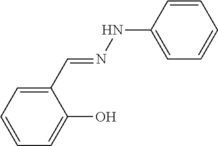 [SMILES: Oc1ccccc1/C=N/Nc1ccccc1]

614-65-3

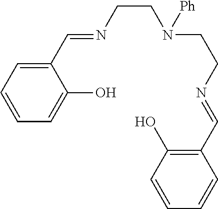 [SMILES: Oc1ccccc1/C=N/CCN(CC/N=C/c1ccccc1O)c1ccccc1]

52761-19-0

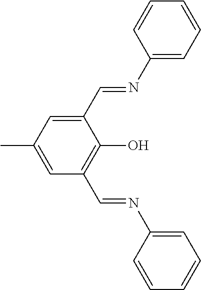 [SMILES: Cc1cc(/C=N/c2ccccc2)c(O)c(/C=N/c2ccccc2)c1]

135713-63-2

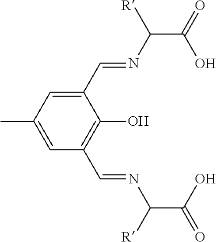

e.g.
1207829-99-9
1207829-97-7
851427-94-6

### SUMMARY OF THE INVENTION

The present invention is directed to a new class of paint driers, primarily for water-borne alkyds although utility is seen in solvent-borne coatings for improved dry times. It solves the problem of the expected reclassification of cobalt-based driers, as the new type of drier is based on the metal vanadium and free of cobalt. It also solves the problem of low hardness with BOC as it can give significantly harder coatings in essentially all resin formulations tested to date. It solves the problem of the slow curing rate of the vanadyl sulfonate driers as the invention cures at a faster rate. It also solves the problem of low adhesion, significantly improving it compared with vanadyl sulfonate driers.

In a first embodiment of the invention, a process is described for improving at least one physical property of an oxidatively curable alkyd resin coating selected from the group consisting of improved resin hardness, reduced resin blistering, and reduced resin dry time, comprising the following steps in any order:
combining a metal source of vanadium, iron, manganese or copper with at least one non-symmetrical ligand with the provisos that:
   (a) when the non-symmetrical ligand is of the type L_{O,N} or L_{O,N,O}, the non-symmetrical ligand comprises at least one of a terminal carboxylic acid group or a phenolic hydroxy group and at least one of a primary amine or a Schiff base or pyridine nitrogen group; and wherein
   (b) when the non-symmetrical ligand is of the type L_{O,N,O} comprising at least one terminal carboxylic acid, the non-symmetrical ligand comprises at least one phenolic hydroxy functional group in addition to the at least one terminal carboxylic acid group;
the improvement being compared to an oxidatively curable alkyd resin coating without the metal source and at least one non-symmetrical ligand and including instead, a conventional metal source and ligand.

In a second embodiment of the first embodiment, the process will have at least one non-symmetrical ligand comprises formula XXV or formula XXVI or formula XXVII or formula XXVIII:
wherein Formula XXV is:

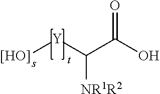

and wherein
   R¹ and R² are independently selected from the group consisting of H, C₁₋₄ linear and branched alkyl;
Y is selected from the group consisting of
   (a) linear and branched, substituted and unsubstituted C₁₋₁₀ alkyl wherein the substituents comprise amine, carbonyl and sulfhydryl groups,
   (b) linear and branched, substituted and unsubstituted C₆₋₂₀ aryl wherein the substituents comprise heteroatoms, and further comprising N and O, and wherein the C₆₋₂₀ aryl further optionally comprise C₅₋₆ and C₅₋₅ and C₆₋₆ fused rings,
   (c) linear and branched C₇₋₄₀ alkylaryl further comprising interposed heteroatoms selected from the group consisting of nitrogen and oxygen and sulfur atoms interspersed within the backbone chain or terminating the chain and further wherein the C₇₋₄₀ alkylaryl further optionally comprise C₅₋₆ and C₅₋₅ and C₆₋₆ fused rings;
   (d) linear and branched, substituted and unsubstituted C₇₋₄₀ arylalkyl, further comprising heteroatoms, and further comprising nitrogen and oxygen and sulfur atoms interspersed within the backbone chain or terminating the chain and further wherein the C₇₋₄₀ arylalkyl further optionally comprise C₅₋₆ and C₅₋₅ and C₆₋₆ fused rings;
s is an integral value ranging from 0 and 1 inclusive;
t is an integral value ranging from 0 and 1 inclusive.
and wherein Formula XXVI is:

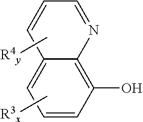

and wherein
   R³ and R⁴ are selected from the group previously defined for Y in formula XXV;
   x is an integral value ranging from 0 to 3;
   y is an integral value ranging from 0 to 3;
and wherein Formula XXVII is:

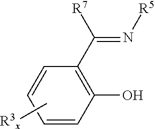

and wherein
   R³ and x are as defined previously for Y Formula XXVI;
   R⁵ and R⁷ are selected from the group previously defined for Y in formula XXV;
and wherein Formula XXVIII is:

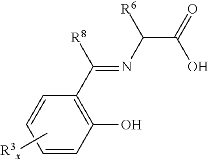

and wherein
   R³ and x are as defined previously for Y for Formula XXVI; and
   R⁶ and R⁸ are selected from the group previously defined for Y in formula XXV.

In a third embodiment of the second embodiment, the non-symmetrical ligand is selected from the group consisting of alanine, arginine, asparagine, aspartic acid, cysteine, glutamic acid, glutamine, glycine, histidine, hydroxyproline, isoleucine, leucine, lysine, methionine, phenylalanine, proline, pyroglutamatic acid, serine, threonine, tryptophan, tyrosine and valine.

In a fourth embodiment of the second embodiment, the non-symmetrical ligand is selected from amino-acid adducts of salen ligands, namely
2-((2-hydroxybenzylidene)amino)-3-(1H-imidazol-4-yl)propanoic acid,
2-((2-hydroxybenzylidene)amino)-3-(1H-indol-3-yl)propanoic acid,
3-hydroxy-2-((2-hydroxybenzylidene)amino)propanoic acid,
2-((2-hydroxybenzylidene)amino)-4-(methylthio)butanoic acid,
2-((2-hydroxybenzylidene)amino)succinic acid,
2-((2-hydroxybenzylidene)amino)pentanedioic acid,
2-((2-hydroxybenzylidene)amino)acetic acid,
6-amino-2-((2-hydroxybenzylidene)amino)hexanoic acid,
2-((2-hydroxybenzylidene)amino)-3-(4-hydroxyphenyl)propanoic acid,
2-((2-hydroxybenzylidene)amino)-3-phenylpropanoic acid,
4-amino-2-((2-hydroxybenzylidene)amino)-4-oxobutanoic acid,
2-((2-hydroxybenzylidene)amino)-3-mercaptopropanoic acid,
3-((2-carboxy-2-((2-hydroxybenzylidene)amino)ethyl)disulfaneyl)-2-((2-hydroxybenzylidene)amino)propanoic acid,
5-guanidino-2-((2-hydroxybenzylidene)amino)pentanoic acid,
2-((2-hydroxybenzylidene)amino)-4-methylpentanoic acid,
1-(2-hydroxybenzylidene)pyrrolidin-1-ium-2-carboxylate, and
2-((1-(2-hydroxyphenyl)ethylidene)amino)-3-(1H-imidazol-4-yl)propanoic acid.

In a fifth embodiment of the first embodiment, the process includes a step wherein the MORS (“Metal on Resins Solids”) value ranges from 0.001 to 1.0 inclusive.

In a sixth embodiment of the first embodiment, the process includes a step wherein the ligand is added in any of the following combinations: premade with the metal, added before or after the metal to the resin or as a prepack system.

In a seventh embodiment of the first embodiment, the process includes a step in which the non-symmetrical ligand is an amino acid selected from the group consisting of tryptophan, serine, arginine, methionine, leucine, proline, glycine, glutamine, lysine, tyrosine, phenalanine, asparagine, cysteine, cystine, and aspartic acid, alanine, isoleucine, threonine, valine and selenocysteine.

In an eighth embodiment of the first embodiment, the process includes a step wherein the ligand is a C₁-C₆ alkyl substituted non-symmetrical amino acid.

In a ninth embodiment of the first embodiment, the process includes a step wherein the ligand is a derivative of 2′-hydroxyacetophenone.

In a tenth embodiment of the first embodiment, the process includes the addition of BOC, namely iron (1+), chloro[dimethyl 9,9-dihydroxy-3-methyl-2,4-di(2-pyridinyl-kN)-7-[(2-pyridinyl-kN)methyl]-3,7-diazabicyclo[3.3.1]nonane-1,4-dicarboxylate-kN3,kN7]-, chloride(1:1) with said non-symmetrical ligand.

In an eleventh embodiment of the seventh embodiment, the process includes the step of adding at least two ligands or blends thereof.

In a twelfth embodiment of the first embodiment, the process includes the addition of at least one additive selected from the group consisting of antiskinning agents, UV stabilisers, dispersants, surfactants, inhibitors, fillers, antistatic agents, flame-retardants, lubricants, antifoaming agents, antifouling agents, bactericides, fungicides, algaecides, insecticides, extenders, plasticisers, antifreezing agents, waxes, thickeners, inorganic or organic, transparent or non-transparent pigments, cosolvents, dispersants, surfactants, inhibitors, fillers, anti-static agents, flame-retardant agents, lubricants, anti-foaming agents, extenders, waxes, thickeners, thixotropic agents, anti-oxidants and anti-skinning agents.

In a thirteenth embodiment of the first embodiment, the metal source and at least one non-symmetrical ligand are used in an alkyd paint or an oxidatively curable ink.

In a fourteenth embodiment of the first embodiment, the metal source and at least one non-symmetrical ligand are used in a composite.

In a fifteenth embodiment, the the metal source and at least one non-symmetrical ligand are water-borne or solvent-borne.

These and other objects of this invention will be evident when viewed considering the detailed description, figures/tables and appended claims.

### BRIEF DESCRIPTION OF THE DRAWINGS

Blistering units are used to evaluate the degree of blistering that may develop when a paint coated on a metal surface is subjected to conditions that will cause blisters, the formation of blisters is relative to some system weakness.

In the tests, metal plates were coated with paint and sealed on the edges with adhesive tape and the lower half of the plates immersed in water for 24 hours. The plates were taken out and looked at for any blistering. The blistering/defects are all compared to a reference drier, in this application, a vanadium drier, V-TS, assigned a number of 2. Coatings with more blisters/defects are assigned a number 3 and coatings with less blisters/defects are assigned a number of 1.

Adhesion testing utilizes a tape firmly applied over a cross-hatch test area and then removed quickly by pulling the tape back off the test area to reveal the amount of coating lifted off by the test tape. The cross-hatched area is then visually compared to ASTM standards D3002 and D #359 as illustrated in FIGS. 4 through 12.

FIG. 1 is a depiction illustrating a blistering rating of 2;

FIG. 2 is a depiction illustrating a blistering rating of 3;

FIG. 3 is a depiction illustrating a blistering rating of 1;

FIG. 4 illustrates a Class 5B rating wherein the edges of the cuts are completely smooth and none of the squares of the lattice detach;

FIG. 5 illustrates a Class 4B rating wherein detachment of small flakes occurs at the intersections of the cuts, a cross-cut area not significantly greater than 5% is affected;

FIGS. 6-7 illustrate a Class 3B rating wherein the coating has flaked along the edges and/or at the intersections of the cuts, a cross-cut area significantly greater than 5%, but not greater than 15% is affected;

FIGS. 8-9 illustrate a Class 2B rating wherein the coating has flaked along the edges of the cuts partly or wholly in large ribbons, and/or has flaked partly or wholly on different parts of the squares wherein a cross-cut area significantly greater than 15%, but not significantly greater than 35% is affected;

FIGS. 10-11 illustrate a Class 1B rating wherein the coating has flaked along the edges of the cuts in large ribbons, and/or some squares have detached partly or wholly, wherein a cross-cut area significantly greater than 35%, but not significantly greater than 65% is affected; and

FIG. 12 illustrates a Class 0B rating, which is any degree of flaking that cannot even be classified by a Class 1B rating.

### DETAILED DESCRIPTION OF THE INVENTION

The best mode for carrying out the invention will now be described for the purposes of illustrating the best mode known to the applicant at the time of the filing of this invention. The examples and figures are illustrative only and not meant to limit the invention, as measured by the scope and spirit of the claims.

Unless the context clearly indicates otherwise: the word “and” indicates the conjunctive; the word “or” indicates the disjunctive; when the article is phrased in the disjunctive, followed by the words “or both” or “combinations thereof” both the conjunctive and disjunctive are intended.

As used in this application, the term “approximately” is within 10% of the stated value, except where noted.

The invention has broad utility in relation to a wide variety of solvent and water-based coating compositions, which term is to be interpreted broadly herein. Examples of coating compositions include clear or colored varnishes, primary coats, filling pastes, glazes, emulsions and floor coverings, e.g. linoleum floor coverings. Embodiments of the invention relate to solvent and water-based paints and inks, particularly paints such as high-specification paints intended for domestic use and paints intended for general industrial applications.

Use of the term “oxidatively curable coating compositions” herein is thus intended to embrace a wide variety of colored (e.g. by way of pigment or ink) and non-colored materials, including oils and binders, which form a continuous coating through the course of oxidative reactions, typically to form cross-linkages and other bond formations. Generically, such coating compositions may be characterized by the presence of typically (poly) unsaturated resins that react to form a solid film on a substrate, the resins being initially present in the oxidatively curable solvent-based coating compositions either as liquids, dissolved in an organic solvent or as solids dispersed in a continuous liquid phase. Reaction to form the desired coating upon curing arises from polymerization reactions initiated by oxidation. Examples of oxidatively curable coating compositions include alkyd-, acrylate-, urethane-, polybutadiene- and epoxy ester-based resins. Typically, the curable (e.g. alkyd resin) portion of the curable composition will comprise between about 1 and about 90% by weight of the total weight of the oxidatively curable solvent-based coating composition, e.g. between about 20 wt. % and about 70% wt. % of the total weight of the oxidatively curable solvent-based coating composition.

Alkyd resins are a particularly important member of the class of oxidatively curable coating compositions and are a well-studied class of resin to which the present invention may be applied. Hereinafter, embodiments of the invention are described with reference to the use of alkyd resins, also referred to as alkyd-based resins or alkyd(-based) binders. Whilst these represent particularly significant embodiments of the invention, the invention is not to be so limited. To be clear: the invention is applicable to a wide range of oxidatively curable coating compositions, typically those comprising at least 1 or 2% by weight of an unsaturated compound (e.g., comprising unsaturated (non-aromatic) double or triple carbon-carbon bonds).

As used herein, the term “alkyd binder” or “alkyd resin” are used interchangeably. Suitable autoxidizable alkyd resin for use in the invention, are in general the reaction product of the esterification of polyhydric alcohols with polybasic acids (or their anhydrides) and unsaturated fatty acids (or glycerol esters thereof), for example derived from linseed oil, tung oil, tall oil as well as from other drying or semi-drying oils. Alkyd resins are well-known in the art and need not to be further described herein. The properties are primarily determined by the nature and the ratios of the alcohols and acids used and by the degree of condensation. Suitable alkyd resins include long oil, medium oil and short oil alkyd resins. As used herein, long oil alkyd resins have an oil content greater than 55%; medium oil alkyd resins have an oil content between 40% and 55%; and short oil alkyd resins have an oil content less than 40%, preferably less than 30%. To improve the performance of the resins, the composition of the long oil, medium oil and short oil alkyd may be modified. For example, polyurethane modified alkyds, silicone modified alkyds, styrene modified alkyds, acrylic modified alkyds (e.g. (meth)acrylic modified alkyds), vinylated alkyds, polyamide modified alkyds, and epoxy modified alkyds or mixtures thereof are also suitable alkyd resins to be used in the present composition.

Preferably, the at least one autoxidizable alkyd binder is selected from a short, medium or long oil unmodified alkyd, a silicone modified alkyd, a polyurethane modified alkyd or a combination thereof. Most preferably, the alkyd binder is a long oil (unmodified) alkyd, a silicone modified alkyd, a polyurethane modified alkyd or a combination thereof.

The amount of alkyd binder in the present compositions can typically range from about 20 wt. % to 98 wt. %, such as about 30 wt. % to about 90 wt. %, preferably about 35 wt. % to 70 wt. % based on the total weight of the composition.

As used herein, the terms “drier” (which are also referred to synonymously as “siccatives” when in solution) refer to organometallic compounds that are soluble in organic solvents and binder as well as in aqueous solvents They are added to unsaturated oils and binders in order to appreciably reduce their drying times, i.e., the transition of their films to the solid phase. Driers are available either as solids or in solution. Suitable solvents are organic solvents and binders or water-based solvents. The driers are present in amounts expressed as weight percent of the metal based on the weight of binder solids (or resin) unless stated otherwise.

As used herein, the term “drier composition” refers to the mixture of driers as presently claimed. The drier composition according to the invention can comprise several drier compounds and results in improved coating hardness, reduced coating peeling and reduced dry time.

Where percentages by weight are referred to herein (wt. % or % w/w), this means, unless a context clearly dictates to the contrary, percentages by weight with respect to the solid resin resultant from curing, i.e. components of the oxidatively curable solvent-based coating compositions that serve to provide the coating upon curing. With an oxidatively curable alkyd coating composition, therefore, the combined weights of the components of the composition that become, i.e., are incorporated into, the alkyd resin coating, i.e., once cured, are those with respect to which weight percentages herein are based. For example, the composition, either resultant from conducting the method according to the first aspect of the invention, or according to the second aspect of the invention, typically comprises about 0.0001 to about 1% w/w, e.g., about 0.0005 to about 0.5% w/w water, or about 0.01 to about 1% w/w, e.g. about 0.05 to about 0.5% w/w water, based on the components of the composition that, when cured, from the coating.

By oxidatively curable solvent-based compositions is meant herein, consistent with the nomenclature used in the art, compositions that are based on organic (i.e., non-aqueous) solvents or inorganic solvents (e.g., water-based). In the case of organic solvents, a non-limiting exemplary list of suitable solvents includes aliphatic (including alicyclic and branched) hydrocarbons, such as hexane, heptane, octane, cyclohexane, cycloheptane and isoparaffins; aromatic hydrocarbons such as toluene and xylene; ketones, e.g. methyl ethyl ketone and methyl isobutyl ketone; alcohols, such as isopropyl alcohol, n-butyl alcohol and n-propyl alcohol; glycol monoethers, such as the monoethers of ethylene glycol and diethylene glycol; monoether glycol acetates, such as 2-ethoxyethyl acetate; as well as mixtures thereof. Isomeric variants are included. Thus, the term hexane embraces mixtures of hexanes. According to embodiments of the invention, the solvent is a hydrocarbyl (i.e., hydrocarbon) solvent, e.g., an aliphatic hydrocarbyl solvent, e.g., solvents comprising mixtures of hydrocarbons. Examples include white spirit and solvents available under the trademarks Shellsol, from Shell Chemicals and Solvesso and Exxsol, from Exxon.

The compositions by the invention comprise a transition metal drier, which is a complex of a transition metal ion and a ligand as defined herein and optionally with additional counter ions complexed with water or solvent molecules.

The transition metal ion used in the invention is vanadium. The valency of the metal may range from +2 to +5. Embodiments of the invention may include mixtures of transition metal ions. Where a vanadium-containing drier is provided this is usually as a V(II), (III), (IV) or (V) compound, where an iron-containing drier is provided, this is usually as an Fe(II) or Fe(III) compound. Where a manganese drier is provided, this is usually as a Mn(II), (III) or (IV) compound.

To enhance the activity of the transition metal ions a so-called accelerating compound, such as a carboxylic acid or a pentadentate amine, is also included. As the language suggests the carboxylic acid or polydentate amine accelerant ligand is a compound capable of coordinating to the transition metal ion by way of more than one donor site within the ligand and serves to accelerate the drying (curing process) of the oxidatively curable coating composition after application.

According to some embodiments of the invention the polydentate amine accelerant ligand is a bi-, tri-, tetra-, penta- or hexadentate ligand coordinating through nitrogen and/or oxygen donor atoms. In particular embodiments of the invention the ligand is a bi-, tri-, tetra-, penta- or hexadentate nitrogen donor ligand, in particular a tri-, tetra-, penta-, or hexadentate nitrogen donor ligand. However, the invention is not so limited. Examples of a wide variety of polydentate accelerant ligands are discussed below.

After preparation, a solution of the metal drier may then be contacted with, e.g., added to, a coating composition at a concentration of 0.001 to 1% MORS (“Metal On Resin Solid”).

The resultant composition, comprising the metal drier will typically be a solution, i.e., a single homogeneous phase or an emulsion or dispersion, e.g., comprising discontinuous regions of aqueous solution comprising the transition metal drier.

As used in this application, the term “Binder solutions (alkyds)” means one of the following: SYNAQUA 4804 (water-borne short oil alkyd, Arkema); SYNAQUA 2070 (water-borne medium oil alkyd, Arkema); Beckosol AQ101 (water-borne long oil alkyd, Polyont Composites USA Inc.); WorleeKyd S 351 (solvent-borne medium oil alkyd, Worlee); and TOD 3AK0211Y (water-reducible alkyd, TOD, China) and other binder solutions having similar characteristics to the named above. In a more generic sense, “alkyd resin(s)” means a synthetic resin made by condensation reaction (release of water) between a polyhydric alcohol (glycerol, etc.) and dibasic acid (or phthalic anhydride). It is the non-volatile portion of the vehicle of a paint. After drying, it binds the pigment particles together with the paint film as a whole.

As used herein, the term (“V-TS”) is oxidovanadium p-toluenesulfonate, illustrated below as formula (I).

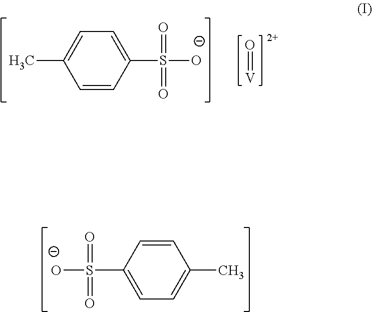

As used herein, BOC is iron (1+), chloro[dimethyl 9,9-dihydroxy-3-methyl-2,4-di(2-pyridinyl-kN)-7-[(2-pyridinyl-kN)methyl]-3,7-diazabicyclo[3.3.1]nonane-1,4-dicarboxylate-kN3, kN7]-, chloride(1:1) illustrated below as Formula (III).

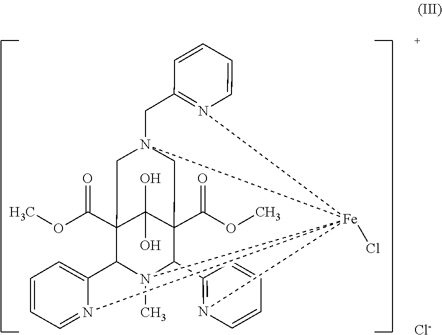

As used in this application, the term “secondary driers”, synonymously “auxiliary driers” means Calcium-Hydrochem (based on Calcium neodecanoate in organic solvents, Borchers; and Octa Soligen Zirconium 10 aqua (Zr-2-ethylhexanoate in organic solvents, Borchers) and other secondary driers having similar characteristics to the named above. Additionally, one or more auxiliary driers may be added to the fully formulated oxidatively curable coating composition. Such auxiliary driers may be optional additional components within, but are often not present in, the formulation of the invention. Such auxiliary driers include fatty acid soaps of zirconium, bismuth, barium, cerium, calcium, lithium, strontium, and zinc. Typically, fatty acid soaps are optionally substituted octanoates, hexanoates and naphthenates. Without being bound by theory, auxiliary driers (sometimes referred to as through driers) are generally understood to diminish the effect of adsorption of the main drier on solid particles often present in an oxidatively curable coating composition. Other non-metal based auxiliary driers may also be present if desired. Concentrations of auxiliary driers within oxidatively curable coating compositions (or formulations of the invention) are typically between about 0.01 wt. % and 2.5 wt. % as is known in the art.

The coating composition may furthermore contain one or more additives conventionally found in curable coating compositions, such as, but not limited to: UV stabilisers, dispersants, surfactants, inhibitors, fillers, antistatic agents, flame-retardants, lubricants, antifoaming agents, antifouling agents, bactericides, fungicides, algaecides, insecticides, extenders, plasticisers, antifreezing agents, waxes and thickeners.

In certain embodiments, the coating compositions of the present invention comprise at least one colorant. The colorant component of the coating composition may comprise one or more inorganic or organic, transparent or non-transparent pigments. Non-limiting examples of such pigments are titanium dioxide, iron oxides, mixed metal oxides, bismuth vanadate, chromium oxide green, ultramarine blue, carbon black, lampblack, monoazo and diazo pigments, anthraquinones, isoindolinones, isoindolines, quinophthalones, phthalocyanine blues and greens, dioxazines, quinacridones and diketo-pyrrolopyrroles; and extender pigments including ground and crystalline silica, barium sulfate, magnesium silicate, calcium silicate, mica, micaceous iron oxide, calcium carbonate, zinc oxide, aluminum hydroxide, aluminum silicate and aluminum silicate, gypsum, feldspar, talcum, kaolin, and the like. The amount of pigment that is used to form the coating composition is understood to vary, depending on the composition application, and can be zero when a clear composition is desired.

The composition according to the invention can be used as a clear varnish or may contain pigments. Examples of pigments suitable for use are metal oxides, such as titanium dioxide or iron oxide, or other inorganic or organic pigments.

The coating composition may furthermore contain one or more additives such as UV stabilisers, cosolvents, dispersants, surfactants, inhibitors, fillers, anti-static agents, flame-retardant agents, lubricants, anti-foaming agents, extenders, plasticisers, anti-freezing agents, waxes, thickeners, thixotropic agents, etc. Furthermore, the coating composition according to the invention may optionally comprise various anti-oxidants and anti-skinning agents known in the art of the formulation of coating compositions, for example: phenol derivatives, e.g. pyrogallol, 2,6-di-tert.butylhydroxytoluene, hydroquinone, octadecyl-3-(3,5-di-tert.butyl-4-hydroxyphenyl) propionate-Irganox® 1076 (available from Ciba SC), bis(2-mercapto-ethyl)-(3-(3,5-di-tert.butyl-4-hydroxyphenyl) propionate) sulphide-Irganox® 1035 (available from Ciba SC), monomethyl ether of hydroquinone, propenyl phenol, 4-acetoxystyrene, iso-eugenol, lauryl gallate; sulphides, e.g. phenothiazine, dodecylsulphide, di(dodecyl)thiodipropionate; phosphines, e.g. trimethylphosphine, tri-n.octylphosphine, triphenylphosphine; phosphites, e.g. trimethylphosphite, triphenylphosphite, tris(nonylphenyl)phosphite, ethyl-bis(2,4-di-tert.butyl-6-methylphenyl)phosphite—Irgafos® 38 (available from Ciba SC), tris(2,4-di-tert.butylphenyl)phosphite—Irgafos® 168 (available from Ciba SC), bis(2,4-di-tert.butylphenyl)pentadiphosphite—Ultranox® 626 (available from General Electric); phosphonites, e.g. tetrakis(2,4-di-tert.butylphenyl)(1,1-biphenyl)-4,4′-diylbisphosphonite—Irgafos® P-EPQ (available from Ciba SC); dioxo-compounds, e.g. 2,4-pentanedione, dibenzoylmethane, 2,4-hexanedione, 1,3-cyclohexanedione, oxopropionic acid, 2-methyl-3-oxosuccinic acid diethyl ester, oxalacetic acid; oximes, e.g. butanone oxime, butyraldehyde oxime, cyclohexanone oxime; hydroxyacetone, diethylhydroxylamine, 3,5-dimethylpyrazole, ascorbic acid, Hindered Amine Light Stabilisers (HALS), e.g. Tinuvin® 123 and Tinuvine® 292 (available from Ciba SC), 2,3-butenediol, dibenzoyloxybutene, dibenzylthiocarbamic acid zinc salt, Vitamin E, Vitamin E acetate, hypophosphorous acid, 2-butylbenzofuran, 3,4-dihydro-2-ethoxy-2H-pyran, dodecylmercaptane, dicyclopentadiene.

The curable coating composition according to the various aspects of the invention may be used as a decorative coating, e.g., applied to wood substrates, such as door or window frames, or for other substrates such as those made of synthetic materials (such as plastics including elastomeric materials), concrete, leather, textile, glass, ceramic or metal. The curable coating composition according to the various aspects of the invention may be used as an industrial coating, e.g., applied to metal substrates, such as for automotive parts, bridges, equipment or for coil coatings. The thus applied composition may then be allowed to cure. The invention also provides a composition, when cured.

Thus, the invention also provides a method comprising applying to a substrate a composition to a substrate. The thus applied composition may then be allowed to cure.

Any known method can be used to apply the coating compositions of the invention to a substrate. Non-limiting examples of such application methods are spreading (e.g., with paint pad or doctor blade, or by brushing or rolling), spraying (e.g., air-fed spray, airless spray, hot spray, and electrostatic spray), flow coating (e.g., dipping, curtain coating, roller coating, and reverse roller coating), and electrodeposition. (See generally, R. Lambourne, Editor, Paint and Surface Coating: Theory and Practice, Eilis Horwood, 1987, page 39 et seq.).

The coating compositions of the present invention can be applied and fully cured at ambient temperature conditions in the range of from about −10° C. to 50° C. Curing of said polymer composition according to the invention typically can proceed very rapidly, and in general can take place at a temperature within the range of from −10° C. to +50° C., in particular from 0° C. to 40° C., more in particular from 3° C. to 25° C. However, compositions of the present invention may be cured by additional heating.

The coating compositions of the present invention may be used as a single coating, a top coating, a base coating in a two-layered system, or one or more layers of a multi-layered system including a clear top coating composition, colorant layer and base coating composition, or as a primer layer. A typical opaque system may comprise: 1 or 2 layers of primer and 1 or 2 layers of topcoat (a total of 3 layers). Alternative opaque systems may comprise: 1 primer layer, 1 layer of midcoat and 1 layer topcoat. Examples of transparent systems may comprise 1 layer of impregnant and 3 layers of topcoats or 3 layers of topcoat for maintenance work.

The invention uses vanadium complex with specific ligands of the type L_{O,N}, more specifically of the type L_{O,N,O} (See Table VI). More specifically, the invention concerns ligands of type ImP, where the first O-group is a phenolic OH and the N-group is an imine or an aromatic pyridine-type nitrogen (see Table VI). Type ImP can be further classified into three types: into phenolic imines bearing an annulated pyridine ring as the imine component (e.g. 8.hydroxyquinoline, 8HQ, and derivatives thereof, see Table VI), phenolic Schiff bases of type HS and the special case of the latter, type HS-AA, in which the Schiff-base is derived from α-amino acids as amine-component (see Table VI). Specific examples for the ligand types HS and HS-AA are shown in Table VII.

Specifically excluded are vanadium-complexes with ligands of type L_{O,N,N,O} including the salen ligand as well the salen ligand derivative XJ (Table III). The current invention therefore covers ligands of the L_{O,N} and L_{O,N,O} structure, specifically of type 8HQ, HS and HS-AA, but not of type L_{O,N,N,O} (See Table VII).

TABLE VII

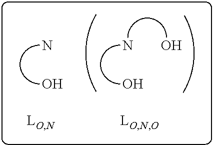

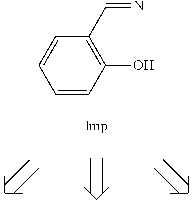

| | | |
|---|---|---|
| 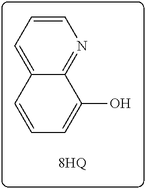 [SMILES: Oc1cccc2cccnc12] | 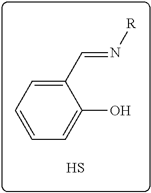 | 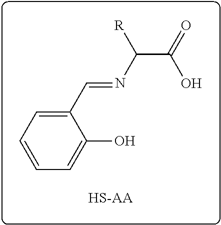 |

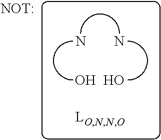

Specific examples of the HS-AA type are illustrated in previously provided Table V as well as specific examples of the type HS shown to the left two entries of Table VIII. Specific non-limiting exemplary examples of the type ImP are illustrated in Table VI.

TABLE VIII

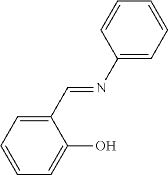 [SMILES: Oc1ccccc1/C=N/c1ccccc1]

HS-1

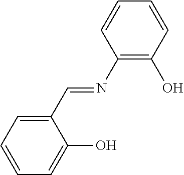 [SMILES: Oc1ccccc1/C=N/c1ccccc1O]

HS-2

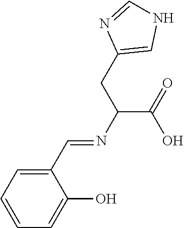 [SMILES: O=C(O)C(Cc1c[nH]cn1)/N=C/c1ccccc1O]

HS-His

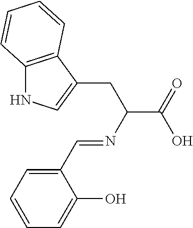 [SMILES: O=C(O)C(Cc1c[nH]c2ccccc12)/N=C/c1ccccc1O]

HS-Trp

The invention uses vanadium complex with specific ligands of the type L_{O,N}, more specifically of the type L_{O,N,O} (See Table VI presented previously). More specifically, the invention concerns ligands of type ImP, where the first O-group is a phenolic OH and the N-group is an imine or an aromatic pyridine-type nitrogen (see Table VI). Type ImP can be further classified into three types: into phenolic imines bearing an annulated pyridine ring as the imine component (e.g. 8.hydroxyquinoline, 8HQ, and derivatives thereof, see Table VI), phenolic Schiff bases of type HS and the special case of the latter, type HS-AA, in which the Schiff-base is derived from α-amino acids as amine-component (see Table VI). Specific examples for the ligand types HS and HS-AA are shown in Table VII presented previously.

Table IX illustrates various amino acids which are useful in the practice of this invention in combination with vanadium, the amino acid group comprising the non-symmetrical ligands: alanine, arginine, asparagine, aspartic acid, cysteine, glutamic acid, glutamine, glycine, histidine, hydroxyproline, isoleucine, leucine, lysine, methionine, phenylalanine, proline, pyroglutamic acid, serine, threonine, tryptophan, tyrosine and valine.

TABLE IX
Amino Acid/Structure
TRP (tryptophan)-formula V

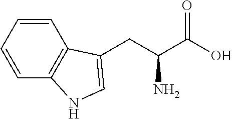 [SMILES: N[C@@H](Cc1c[nH]c2ccccc12)C(=O)O]

SER (serine)-formula VI

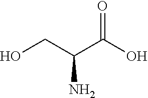

ARG (arginine)-formula VII

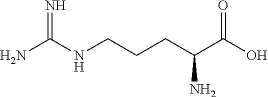 [SMILES: N=C(N)NCCC[C@H](N)C(=O)O]

Met (methionine)-formula VIII

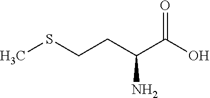

LEU (leucine)-formula IX

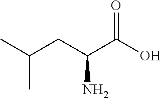

PRO (proline)-formula X

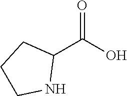

GLY (glycine)-formula XI

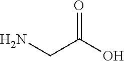

GLU (glutamine)-formula XII

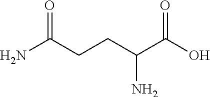

LYS (lysine)-formula XIII

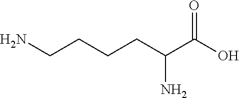

TYR (tyrosine)-formula XIV

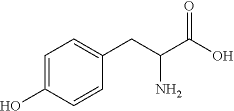 [SMILES: NC(Cc1ccc(O)cc1)C(=O)O]

PHE (phenylalanine)-formula XV

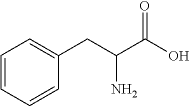 [SMILES: NC(Cc1ccccc1)C(=O)O]

ASN (asparagine)-formula XVI

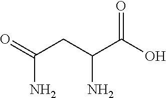

CYS (cysteine)-formula XVII

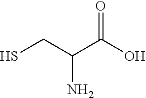

Cystine-formula XVIII

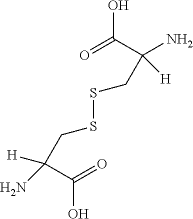 [SMILES: NC(CSSCC(N)C(=O)O)C(=O)O]

ASP (aspartic acid)-formula XIX

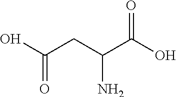

HIS (histidine) formula XX

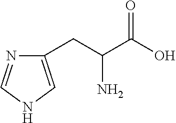 [SMILES: NC(Cc1c[nH]cn1)C(=O)O]

THR (threonine)-formula XXI

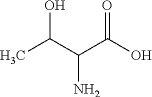

VAL (valine)-formula XXII

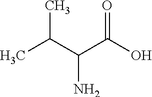

Alanine (ALA)-formula XXIII

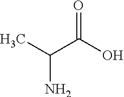

Isoleucine (ILE)-formula XXIV

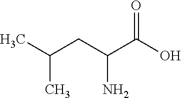

When viewed more generically, the structure of the at least one non-symmetrical ligand will have the provisos that
(a) when the non-symmetrical ligand is of the type L_{O,N} or L_{O,N,O}, the non-symmetrical ligand comprising at least one terminal carboxylic acid group; or
(b) when the non-symmetrical ligand of the type L_{O,N} or L_{O,N,O}, comprising at least one amine group; and wherein
(c) when the non-symmetrical ligand is of the type L_{O,N,O}, the non-symmetrical ligand comprises at least one hydroxyl group in addition to the at least one terminal carboxylic acid group; or
(d) when the non-symmetrical ligand is of the type L_{O,N,O}, the non-symmetrical ligand comprises at least one imine or pyridine type nitrogen donor group and at least one oxygen donor group which can be either a phenolic or a carboxylic oxygen atom;
the improvement being compared to an oxidatively curable alkyd resin coating with the metal source and without at least one non-symmetrical ligand and including instead, a conventional metal source and ligand.

More generically, the at least one non-symmetrical ligand comprises formula XXV or formula XXVI or formula XXVII or formula XXVIII:
wherein Formula XXV is:

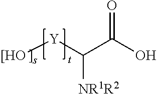

and wherein
   R¹ and R² are independently selected from the group consisting of H, C₁-4 linear and branched alkyl;
Y is selected from the group consisting of
   (a) linear and branched, substituted and unsubstituted C₁₋₁₀ alkyl wherein the substituents comprise amine, carbonyl and sulfhydryl groups,
   (b) linear and branched, substituted and unsubstituted C₆₋₂₀ aryl wherein the substituents comprise heteroatoms, and further comprising N, and optionally including C₅₋₆ and C₅₋₅ and C₆₋₆ fused rings,
   (c) linear and branched C₇₋₄₀ alkylaryl further comprising interposed heteroatoms selected from the group consisting of nitrogen and sulfur atoms interspersed within the backbone chain or terminating the chain;
   (d) linear and branched, substituted and unsubstituted C₇₋₄₀ arylalkyl, further comprising heteroatoms, and further comprising nitrogen and sulfur atoms interspersed within the backbone chain or terminating the chain;
s is an integral value ranging from 0 and 1 inclusive;
t is an integral value ranging from 0 and 1 inclusive.
and wherein Formula XXVI is:

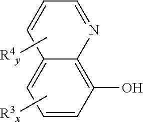

and wherein
   R³ and R⁴ are selected from the group previously defined for Y;
   x is an integral value ranging from 0 to 3;
   y is an integral value ranging from 0 to 3;
and wherein Formula XXVII is:

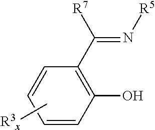

and wherein
   R³ and x are as defined previously for Formula XXVI;
   R⁵ and R⁷ selected from the group previously defined for Y;
and wherein Formula XXVIII is:

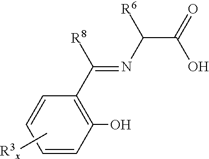

and wherein
   R³ and x are as defined for Formula XXVI;
   R⁶ and R⁸ selected from the group previously defined for Y;

As used herein, and unless otherwise stated, the term “alkyl” means straight and branched chain saturated acyclic hydrocarbon monovalent groups; said alkyl group may further optionally include one or more suitable substituents independently selected from the group consisting of amino, halogen, hydroxy, sulfhydryl, haloalkyl, alkoxy and the like. Specific non-limiting examples of straight-chain or branched alkyl groups are C₁₋₂₀ alkyls, e.g., methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl and stearyl groups. It is recognized that the alkyl may be interrupted with oxygen, sulfur or nitrogen.

As used herein, and unless otherwise stated, the term “alkenyl” means straight and branched chain unsaturated acyclic hydrocarbon monovalent groups; said alkenyl group may further optionally include one or more suitable substituents independently selected from the group consisting of amino, halogen, hydroxy, sulfhydryl, haloalkyl, alkoxy and the like. Specific non-limiting examples of the straight-chain or branched alkenyl groups are those having 2 to 30 carbon atoms wherein the position of the double bond may vary, such as butenyl, pentenyl, hexenyl, heptenyl, octenyl, nonenyl, decenyl, undecenyl, dodecenyl, tridecenyl, tetradecenyl, pentadecenyl, hexadecenyl, heptadecenyl, and octadecenyl groups. It is once again, recognized that the alkenyl may be interrupted with oxygen, sulfur or nitrogen.

As used herein, and unless otherwise stated, the terms “cycloaliphatic” refer to a mono- or polycyclic saturated hydrocarbon monovalent group having from 3 to 10 carbon atoms, or a C₇₋₁₀ polycyclic saturated hydrocarbon monovalent group having from 7 to 10 carbon atoms. Specific non-limiting examples of the cycloaliphatic or cyclic alkyl groups which may have substituents are cycloalkyl groups having 5 to 7 carbon atoms such as cyclopentyl, cyclohexyl and cycloheptyl groups, and the alkylcycloalkyl groups having 6 to 11 carbon atoms wherein the position of the alkyl group may vary, such as methylcyclopentyl, dimethylcyclopentyl, methylethylcyclopentyl, dimethylcyclopentyl, methylcyclohexyl, dimethylcyclohexyl, methylethylcyclohexyl, diethylcyclohexyl, methylcycloheptyl, dimethylcycloheptyl, methylcycloheptyl, and diethylcycloheptyl groups. It is once again, recognized that the cycloaliphatic may be interrupted with oxygen, sulfur or nitrogen.

As used herein, and unless otherwise stated, As used herein, and unless otherwise stated, the terms “aromatic” and “aryl” designate any mono- or polycyclic aromatic monovalent hydrocarbon group having from 6 up to 30 carbon atoms, including fused benzo-C₄₋₈ cycloalkyl groups (the latter being as defined above), all of the said groups being optionally substituted with one or more substituents independently selected from the group consisting of halogen, amino, haloalkyl, hydroxyl, sulfhydryl and nitro.

As used herein, and unless otherwise stated, the term “heterocyclic” means a mono- or polycyclic, saturated or mono-unsaturated or poly-unsaturated monovalent hydrocarbon group having from 2 up to 15 carbon atoms and including one or more heteroatoms in one or more rings, each of said rings having from 3 to 10 atoms (and optionally further including one or more heteroatoms attached to one or more carbon atoms of said ring, for instance in the form of a carbonyl or thiocarbonyl or selenocarbonyl group, and/or to one or more heteroatoms of said ring, each of said heteroatoms being independently selected from the group consisting of nitrogen, oxygen, sulfur, selenium and phosphorus, also including groups wherein a heterocyclic ring is fused to one or more aromatic hydrocarbon rings for instance in the form of benzo-fused, dibenzo-fused or naphtho-fused heterocyclic groups, including all possible isomeric forms thereof, wherein each carbon atom of said heterocyclic ring may be independently substituted with a substituent selected from the group consisting of halogen, nitro, C₁₋₇ alkyl (such as above defined, in particular methyl), C₃₋₇ alkenyl, trifluoromethyl, C₃₋₁₀ cycloalkyl, aryl, arylalkyl, alkylaryl, hydroxyl, sulfhydryl, alkoxy (such as above defined, in particular methoxy), aryloxy, arylalkyloxy, thio C₁₋₇ alkyl, thio C₃₋₁₀ cycloalkyl, thioaryl, arylalkylthio, cyano, carboxylic acid or esters thereof; depending upon the number of unsaturations in each of said rings, heterocyclic groups may be sub-divided into heteroaromatic (or “heteroaryl”) groups and non-aromatic heterocyclic groups; when a heteroatom of the said non-aromatic heterocyclic group is nitrogen, the latter may be substituted with a substituent selected from the group consisting of C₁₋₇ alkyl, C₃₋₁₀ cycloalkyl, aryl, arylalkyl and alkylaryl (each of said groups being as defined herein).

As used herein, and unless otherwise stated, the term “alkoxy” refer to substituents wherein an alkyl group is attached to an oxygen atom through a single bond.

As used herein, and unless otherwise stated, the terms “halo” or “halogen” means any atom selected from the group consisting of fluoro, chloro, bromo and iodo.

As used herein, and unless otherwise stated, the term “arylalkyl” refers to an aliphatic saturated hydrocarbon monovalent group onto which an aryl group (such as defined above) is attached, and wherein the said aliphatic or aryl groups may be optionally substituted with one or more substituents independently selected from the group consisting of halogen, amino, hydroxyl, sulfhydryl, alkyl, haloalkyl and nitro. Specific examples of the arylalkyl groups are those having 7 to 40 carbon atoms wherein the alkyl group may be straight-chain or branched, such as benzyl, phenylethyl, phenylpropyl, phenylbutyl, phenylpentyl and phenylhexyl groups.

As used herein, and unless otherwise stated, the term “alkylaryl” refers to an aryl group (such as defined above) onto which an aliphatic saturated hydrocarbon monovalent group is attached, and wherein the said aliphatic or aryl groups may be optionally substituted with one or more substituents independently selected from the group consisting of halogen, amino, hydroxyl, sulfhydryl, alkyl, trifluoromethyl and nitro. Specific non-limiting examples of the unsubstituted or alkyl-substituted aryl groups are the aryl groups having 6 to 18 carbon atoms such as phenyl, diphenyl and naphthyl groups, and alkylaryl groups having 7 to 40 carbon atoms wherein the alkyl group may be straight-chain or branched and may be bonded to any position on the aryl group, such as tolyl, xylyl, ethylphenyl, propylphenyl, butylphenyl, pentylphenyl, hexylphenyl, heptylphenyl, octylphenyl, nonylphenyl, decylphenyl, undecylphenyl, dodecylphenyl, diethylphenyl, dibutylphenyl and dioctylphenyl groups. The alkylaryl groups may additionally have substituents including functional groups such as alkoxy, hydroxy, cyano, nitro, halides, carboxylic acids, etc.

As used herein, and unless otherwise stated, the term “acyl” refers to a substituent derived from an acid such as an organic monocarboxylic acid, a carbonic acid, a carbamic acid (resulting into a carbamoyl substituent) or the thioacid or imidic acid (resulting into a carbamidoyl substituent) corresponding to said acids, wherein said acids comprise an aliphatic, aromatic or heterocyclic group in the molecule. A more specific kind of “acyl” group within the scope of the above definition refers to a carbonyl(oxo) group adjacent to an alkyl, a cycloalkyl, an aryl, an arylalkyl or a heterocyclic group, all of them being such as herein defined.

As used herein, and unless otherwise stated, the term “heterocyclic” means a mono- or polycyclic, saturated or mono-unsaturated or poly-unsaturated monovalent hydrocarbon group having from 2 up to 15 carbon atoms and including one or more heteroatoms in one or more rings, each of said rings having from 3 to 10 atoms (and optionally further including one or more heteroatoms attached to one or more carbon atoms of said ring, for instance in the form of a carbonyl or thiocarbonyl or selenocarbonyl group, and/or to one or more heteroatoms of said ring, each of said heteroatoms being independently selected from the group consisting of nitrogen, oxygen, sulfur, selenium and phosphorus, heterocyclic groups, including all possible isomeric forms thereof, wherein each carbon atom of said heterocyclic ring may be independently substituted with a substituent selected from the group consisting of halogen, nitro, C₁₋₇ alkyl (such as above defined, in particular methyl), C₃₋₇ alkenyl, trifluoromethyl, C₃₋₁₀ cycloalkyl, hydroxyl, sulfhydryl, C₁₋₇ alkoxy (such as above defined, in particular methoxy), thio C₁₋₇ alkyl, thio C₃₋₁₀ cycloalkyl, cyano, carboxylic acid or esters. depending upon the number of unsaturations in each of said rings, heterocyclic groups may be sub-divided into heteroaromatic (or “heteroaryl”) groups and non-aromatic heterocyclic groups; when a heteroatom of the said non-aromatic heterocyclic group is nitrogen, the latter may be substituted with a substituent selected from the group consisting of C₁₋₇ alkyl, C₃₋₁₀ cycloalkyl, aryl, arylalkyl and alkylaryl (each of said groups being as defined herein).

As used herein, and unless otherwise stated, the term “alkoxy” refer to substituents wherein an alkyl group is attached to an oxygen atom through a single bond.

As used herein, and unless otherwise stated, the terms “halo” or “halogen” means any atom selected from the group consisting of fluoro, chloro, bromo and iodo.

As used herein, and unless otherwise stated, the term “acyl” refers to a substituent derived from an acid such as an organic monocarboxylic acid, a carbonic acid, a carbamic acid (resulting into a carbamoyl substituent) or the thioacid or imidic acid (resulting into a carbamidoyl substituent) corresponding to said acids, wherein said acids comprise an aliphatic, aromatic or heterocyclic group in the molecule. A more specific kind of “acyl” group within the scope of the above definition refers to a carbonyl(oxo) group adjacent to an alkyl, a cycloalkyl, an aryl, an arylalkyl or a heterocyclic group, all of them being such as herein defined.

The vanadium-complexes with these ligands can be prepared in various ways: Several vanadium sources, including VOSO₄, VO(H₂O)₅(pTsO)₂ (“V-TS”), Na₃VO₄, V₂O₅, VO(acac)₂ and NH₄VO₃ can be used to react with the preformed ligand.

This can be done prior to mixing the drier with the paint, binder or formulation (short or long term), or in the paint, binder or formulation by adding the vanadium source and ligand separately.

Vanadium complexes with the ligands of type HS and HS-AA can also be synthesized in a one-pot fashion by reacting the reagents required for the ligand synthesis in the presence of a suitable vanadium source (including VOSO₄, VO(H₂O)₅(pTsO)₂ Na₃VO₄, V₂O₅ VO(acac)₂ and NH₄VO₃), in order to receive a drier solution ready to use. This simplifies the procedure as the ligand does not have to be synthesized and isolated prior to reacting it with the vanadium source.

The alkyd binders used were SYNAQUA 4804 (a water-borne short oil alkyd from Arkema), Synaqua 2070 (a water-borne medium oil alkyd from Arkema), TOD 3AK0211Y (a water-reducible alkyd from TOD, China) and Beckosol AQ 206 (a water-borne medium oil alkyd from Polyont Composites USA Inc.).

The drier solutions used were Borchi Oxy-Coat 1101 (BOC 1101, in water, Borchers), Borchers Deca Cobalt 7 aqua (Deca Co 7a, in water dispersible oil, Borchers; synonymously cobalt neodecanoate (cobalt (2+); 7,7-dimethyloctanoate)) (see formula IV),

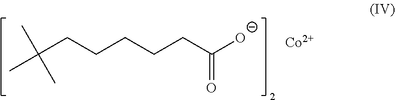

WD016 (an aqueous suspension of a cobalt drier at 8-10% Co, TOD, China) and V-TS (a vanadium-based drier, 9.4% V, courtesy of Prof. Jan Honzíček, University of Pardubice, Czech Republic; generally used as a stock solution of ca. 10% in DMSO or in a mixture of higher-boiling alcohols and esters). See formula (I).

The ligands 8-hydroxyquinoline (8HQ), 2-((Phenylimino)methyl) phenol (HS-1), 2-Salicylideneaminophenol (HS-2) and (S,S)-(+)-N,N′-Bis(3,5-di-tert-butylsalicylidene)-1,2-cyclohexanediamine (XJ) were purchased from commercial sources and used as received.

The invention will now be described by a series of Tables. The formulations used were the following:

TABLE X
formulation vSAcc (Synaqua 4804-based clear coat, water borne)

| Entry | Ingredient | Type | Amount |
|---|---|---|---|
| 1 | Synaqua 4804 | Resin | 95.0 |
| 2 | Borchi Gel 0435 | Rheology modifier | 1.5 |
| 3 | DBE-5 | Additive | 3.5 |

Resin solid content: 30.2%

TABLE XI
formulation 11Ya-cc (TOD 3AK0211Y-based clear coat, water borne)

| Entry | Ingredient | Type | Amount |
|---|---|---|---|
| 1 | TOD 3AK0211Y (72% solid) | Resin | 250.0 |
| 2 | Ethanolamine | Amine | 3.4 |
| 3 | Ethylene glycol butyl ether | Solvent | 12.5 |
| 4 | deionized water | Solvent | 301.0 |
| 5 | NaNO2 20% aq. | Anti flash rust | 4.0 |
| 6 | Borchi ® Gol 1375, Borchers | Wetting agent | 0.5 |
| 7 | Borchi ® Gel 0620 (50%), Borchers | Rheology modifier | 1.0 |

Resin solid content: 31.4%

TABLE XII
formulation 11Ya-wp (TOD 3AK0211Y-based white paint, water borne)

| Entry | Ingredient | Type | Amount |
|---|---|---|---|
| 1 | 11Ya-cc | Clear coat | 70 |
| 2 | deionized water | Solvent | 8.2 |
| 3 | Borchi ® Gen 1252, Borchers | Dispersing agent | 0.6 |
| 4 | Aminopropanol 95% | Amine | 0.1 |
| 5 | Borchers ® AF 1171, Borchers | Additive | 0.1 |
| 6 | R996 Titanium dioxide | Pigment | 21.0 |

Resin solid content: 22.0%

### Methods

The formulations to be used for casting films were prepared by weighing an appropriate amount of drier, usually a stock solution of defined concentration, into a plastic vial, followed by the binder solution or formulation. The amount of drier was calculated referring to the value of dry material as specified for each binder solution. Mixing was achieved by placing the vial into a speed mixer (SpeedMixer DAC 150.1 FVZ) and rotating it with 2000 rounds per minute for two minutes. Generally, a homogeneous-looking mixture was received. This was left under ambient conditions for about 24 hours before films were cast.

For the formulation vSAcc, dry times in hours were measured on B.K. drying recorders model 3 (The Mickle laboratory engineering Co Ltd.) in order to find the time required to reach the drying states of set-to-touch (ST, i.e. no longer moving freely through the soft coating but starting to rip the hardening film), tack-free (TF, i.e. no longer ripping the film but still leaving a continuous line on the coating) and dry-hard (DH, i.e. not leaving any mark on the film).

A film of 100 μm thickness was cast on a glass strip (30×2.4 cm) by using a steel cube applicator. This is then placed on the dry time recorder, a needle was put on the film, the recorder was set for measurement over 24 hours and started. The starting point where the needle was put onto the film was marked on the glass. The drying time was read from the marks left on the film after 24 hours. Dry times given as “24 h” indicate dry times of >24 h, as times longer than 24 hours could not have been determined.

Films of 100 μm thickness were cast on glass sheets (15×9 cm) for measurement of hardness at the same time as when casting films for dry time recording. These were evaluated on a pendulum hardness tester after the drying times given. Pendulum hardness was measured on a TQC Sheen Pendulum Hardness Tester SP0500 by using the Konig method (measuring the time of oscillations in seconds, starting at an initial amplitude of 6° and until an amplitude of 3° is reached). Softer material dampens the pendulum's oscillations more quickly than harder material, so softer material has a lower hardness value in seconds than harder material.

For the formulations 11Ya-cc and 11Ya-wp, dry times were measured in days by placing a filter paper onto the coating on a glass plate and placing a weight of 200 g with a defined surface area on top of the filter paper for 30 seconds. The state of “dry hard” was reached when the filter paper no longer sticked to the coating after this treatment.

The coating of all glass plates, recording of dry time, measurement of hardness and storage was performed in a climate-controlled room with a temperature of 23° C. and a humidity of ca. 50%.

Blistering and adhesion was measured after a 24-hour water resistance test. For this, steel plates were coated in the same manner as the glass plates and dried for 24 hours. Then the edges were sealed with sticky tape and the lower half of the plates were immersed in deionized water for 24 hours. Then the plates were taken out of the water, dried for one hour, noted for any blistering and ranked versus vanadium reference drier (V-TS) as follows, 2 was assigned to the coatings with V-Ts, coatings with less defects/less blistering are ranked as 1 and with more defects/more blistering are ranked as 3. Later the same steel plates were subjected to a crosscut and adhesion test, following the standard ASTM Designation D3359-17.

Catalyst concentrations are given in metal %, referring to the catalyst's metal amount relative to the solid content of the binder and formulation, resp., which is employed. This is also abbreviated MORS, metal on resin solid. MORS is calculated in the following way:

$$M O R S = \frac{{m}_{d} \times M {C}_{d}}{\frac{S {C}_{f}}{100 \%} \times {m}_{f}}$$

with the variables defined as follows: m_{d}: mass of the drier or drier solution, in g; MC_{d}: metal content of the drier (solution) in %; SC_{f}: solid content (of binder) in the formulation, in %; and m_{f}: mass of the formulation, in g.

Specific examples of preparation are given below:

### Example 1: Synthesis of V*8HQ from VO(Acac)₂ and 8HQ (V*8HQ A)

Into a vial, VO(acac)₂ (164 mg, 0.62 mmol) and 8-hydroxyquinoline (8HQ, 180 mg, 1.24 mmol, 2.0 equiv.) are added, followed by DMSO (5.99 g). The solution is stirred until it becomes homogeneous, upon which it slowly develops a dark colour. It is used without further treatment, with a metal content of 0.50%.

### Example 2: Synthesis of V*8HQ from V-TS and 8HQ Prior to Making the Formulation (V*8HQ B)

Into a container for making test formulations, a solution of V-TS in DMSO (76 mg, 10.0 weight %) and a solution of 8HQ in DMSO (82 mg, 5.0 weight %, 2.0 molar equivalents) are added. Upon mixing the two, the solution turns gold brown. An alkyd formulation is added directly afterwards, followed by mixing everything in a speed-mixer.

### Example 3: Synthesis of V*HS-1 from V-TS and HS-1 Prior to Making the Formulation (V*HS-1 A)

Into a container for making test formulations, a solution of V-TS in a mixture of a higher-boiling alcohol and ester (23 mg, 11.8 weight %) and a solution of HS-1 in a mixture of a higher-boiling alcohol and ester (105 mg, 1.0 weight %, 1.1 molar equivalents) are added. Upon mixing the two, the solution turns yellow. An alkyd formulation is added directly afterwards, followed by mixing everything in a speed-mixer.

### Example 4: Synthesis of V*HS-2 from VO(Acac)₂ and HS-2 (V*HS-2 A)

Into a vial, VO(acac)₂ (99 mg, 0.37 mmol) and 2-(2-hydroxybenzylideneamino) phenol (HS-2, 80 mg, 0.37 mmol, 1.0 equiv.) are added, followed by DMSO (1.92 g). The solution is stirred until it becomes homogeneous, upon which it slowly develops a dark colour. It is used without further treatment, with a metal content of 0.90%.

### Example 5: Synthesis of V*HS-2 from Na₃VO₄ and HS-2 (V*HS-2 B)

Into a round bottom flask, Na₃VO₄ (72 mg, 0.39 mmol) and 2-(2-hydroxybenzylideneamino) phenol (HS-2, 84 mg, 0.39 mmol, 1.0 equiv.) are added, followed by DMSO (1.70 g), water (0.39 g) and acetic acid (0.078 g, 1.29 mmol, 3.3 equiv.). The resulting mixture is stirred until it becomes homogeneous, upon which it develops a dark colour. It is used without further treatment, with a metal content of 0.86%.

### Example 6: Synthesis of V*HS-2 from V-TS and HS-2 Prior to Making the Formulation (V*HS-2 C)

Into a container for making test formulations, a solution of V-TS in a mixture of a higher-boiling alcohol and ester (107 mg, 11.8 weight %) and a solution of HS-2 in a mixture of mixture of a higher-boiling alcohol and ester (129 mg, 3.9 weight %, 1.0 molar equivalent) are added. Upon mixing the two, the solution turns red brown. An alkyd formulation is added directly afterwards, followed by mixing everything in a speed-mixer.

### Example 7: Synthesis of the Ligand HS-His

N-[(2-Hydroxyphenyl)methylene]-L-histidine (HS-His) was synthesized according to a procedure published in C. Fattuoni, S. Vascellari, T. Pivetta, Amino Acids 2020, 52, 397-407.

### Example 8: Synthesis of V*HS-His from V-TS and HS-His Prior to Making the Formulation (V*HS-His A)

Into a container for making test formulations, a solution of V-TS in DMSO (77 mg, 10.0 weight %) and a solution of HS-His in DMSO (96 mg, 4.0 weight %, 1.0 molar equivalents) are added. Upon mixing the two, the solution turns gold brown. An alkyd formulation is added directly afterwards, followed by mixing everything in a speed-mixer.

### Example 9: Synthesis of V*HS-His from V₂O₅ and HS-His (V*HS-His B)

Into a round bottom flask, V₂O₅ (48 mg, 0.27 mmol) and HS-His (69 mg, 0.27 mmol, 1.0 equiv.) are added, followed by DMSO (1.75 g). The solution is stirred in an oil bath of 100° C. for 3 hours, upon which it slowly develops a dark colour and becomes homogeneous. It is used without further treatment, with a metal content of 0.72%.

### Example 10: Synthesis of VHS-His from Na₃VO₄ and HS-His (V*HS-His C)

Into a round bottom flask, Na₃VO₄ (30 mg, 0.16 mmol) and HS-His (43 mg, 0.16 mmol, 1.0 equiv.) are added, followed by DMSO (0.60 g), water (0.10 g) and acetic acid (0.03 g, 0.49 mmol, 3.1 equiv.). The resulting mixture is stirred for one hour until it becomes homogeneous and develops a dark colour. It is used without further treatment, with a metal content of 1.01%.

### Example 11: Synthesis of V*HS-His from VO(acac)₂ and HS-His (V*HS-His D)

Into a round bottom flask, VO(acac)₂ (71 mg, 0.027 mmol) and HS-His (70 mg, 0.027 mmol, 1.0 equiv.) are added, followed by DMSO (1.79 g). The resulting mixture is stirred and soon becomes homogeneous and develops a dark color. It is used without further treatment, with a metal content of 0.71%.

### Example 12: Synthesis of V*HS-His from V-TS and HS-His in the Formulation (V*HS-His E)

Into a container for making test formulations, a solution of V-TS in DMSO (131 mg, 10.0 weight %) and an alkyd formulation is added, followed by speed mixing. Then, solid HS-His (12.5 mg, 2.0 equiv.) is added to the mixture, followed by speed mixing.

### Example 13: Synthesis of V*HS-His from V₂O₅ in a Two-Step One-Pot Fashion (V*HS-His F)

Into a round bottom flask, L-histidine (114 mg, 0.73 mmol, 2.3 equiv.), DMSO (3.13 g), acetic acid (52 mg, 0.86 mmol, 2.7 equiv.) and salicylaldehyde (88 mg, 0.72 mmol, 2.3 equiv.) are added and stirred for 30 minutes at ambient temperature. To the yellow mixture, V₂O₅ (57 mg, 0.31 mmol, 1.0 equiv.) is added. The heterogeneous yellowish mixture is stirred in an oil bath of 60-70° C. over night, until it becomes dark brown. It is used without further treatment, with a metal content of 0.93%.

### Example 14: Synthesis of V*HS-His from Na₃VO₄ in a Two-Step One-Pot Fashion (V*HS-His G)

Into a round bottom flask, Na₃VO₄ (300 mg, 0.16 mmol), L-histidine (256 mg, 0.16 mmol, 1.0 equiv.), DMSO (3.96 g), salicylaldehyde (219 mg, 0.18 mmol, 1.1 equiv.), water (1.04 g) and acetic acid (302 mg, 0.50 mmol, 3.1 equiv.) are added. The dark mixture is stirred at ambient temperature until it becomes homogeneous. It is used without further treatment, with a metal content of 1.37%.

### Example 15: Synthesis of V*2 HS-His from Na₃VO₄ in a Two-Step One-Pot Fashion (V*HS-His G2)

Into a round bottom flask, Na₃VO₄ (297 mg, 0.16 mmol), L-histidine (520 mg, 0.33 mmol, 2.1 equiv.), DMSO (5.0 g), salicylaldehyde (397 mg, 0.33 mmol, 2.0 equiv.), water (0.94 g) and acetic acid (290 mg, 0.48 mmol, 3.0 equiv.) are added. The dark mixture is stirred at ambient temperature until it becomes homogeneous. It is used without further treatment, with a metal content of 1.11%.

### Example 16: Synthesis of V*HS-His from V-TS in a Two-Step One-Pot Fashion (V*HS-His H)

Into a round bottom flask, NaOAc (193 mg, 1.42 mmol, 2.4 equiv.), L-histidine (110 mg, 0.71 mmol, 1.2 equiv.), DMSO (3.37 g), and salicylaldehyde (88 mg, 0.72 mmol, 1.2 equiv.) are added and stirred for 30 minutes at ambient temperature. To the yellow mixture, V-TS (299 mg, 0.60 mmol, 1.0 equiv.) is added. The dark mixture is stirred at ambient temperature over night, until it becomes homogeneous. It is used without further treatment, with a metal content of 0.69%.

### Example 17: Synthesis of V*HS-His from VOSO₄ in a Two-Step One-Pot Fashion (V*HS-His I)

Into a round bottom flask, NaOAc (194 mg, 1.42 mmol, 2.4 equiv.), L-histidine (114 mg, 0.73 mmol, 1.2 equiv.), DMSO (3.18 g), and salicylaldehyde (87 mg, 0.71 mmol, 1.2 equiv.) are added and stirred for 30 minutes at ambient temperature. To the yellow mixture, VOSO₄ pentahydrate (153 mg, 0.60 mmol, 1.0 equiv.) and water (0.55 g) is added. The mixture is stirred at ambient temperature for three days, until it becomes homogeneous and dark brown. It is used without further treatment, with a metal content of 0.71%.

### Example 18: Synthesis of VHS-His from VOSO₄ in a Two-Step One-Pot Fashion, Using Excess Vanadium (V*HS-His 12)

Into a round bottom flask, NaOAc (93 mg, 0.68 mmol, 1.1 equiv.), L-histidine (57 mg, 0.37 mmol, 0.6 equiv.), DMSO (2.27 g), and salicylaldehyde (43 mg, 0.35 mmol, 0.6 equiv.) are added and stirred for 30 minutes at ambient temperature. To the yellow mixture, VOSO₄ pentahydrate (154 mg, 0.61 mmol, 1.0 equiv.) and water (0.41 g) is added. The mixture is stirred at ambient temperature for seven days, after which it had become homogeneous and dark brown. It is used without further treatment, with a metal content of 1.02%.

### Example 19: Synthesis of V*HS-His from VO(Acac)₂ in a Two-Step One-Pot Fashion (V*HS-His J)

Into a round bottom flask, L-histidine (113 mg, 0.73 mmol, 1.2 equiv.), DMSO (2.54 g), and salicylaldehyde (85 mg, 0.70 mmol, 1.2 equiv.) are added and stirred for 30 minutes at ambient temperature. To the yellow mixture, VO(acac)₂ (160 mg, 0.60 mmol, 1.0 equiv.) is added. The green-brown mixture is stirred at ambient temperature over night, until it becomes homogeneous. It is used without further treatment, with a metal content of 1.06%.

### Example 20: Synthesis of V*HS-AA from V-TS in a Two-Step One-Pot Fashion

Analogous to the synthesis of a V*HS-His solution in two-step one-pot fashion from V-TS, also the complexes with ligands of type HS-AA were synthesized with the amino acids cystine, cysteine (Cys), methionine (Met), aspartic acid (Asp), glutamic acid (Glu), tryptophan (Trp), lysine (Lys), tyrosine (Tyr), phenylalanine (Phe), arginine (Arg), leucine (Leu), proline (Pro), asparagine (Asn), glycine (Gly), and serine (Ser).

### Example 21: Synthesis of VHS-(HW) from VOSO₄ in a Two-Step One-Pot Fashion (V*HS-HW)

Into a round bottom flask, NaOAc (184 mg, 1.35 mmol, 2.1 equiv.), L-histidine (55 mg, 0.35 mmol, 0.6 equiv.), L-tryptophan (74 mg, 0.36 mmol, 0.6 equiv.), DMSO (2.27 g), and salicylaldehyde (86 mg, 0.71 mmol, 1.1 equiv.) are added and stirred for 30 minutes at ambient temperature. To the yellow mixture, VOSO₄ pentahydrate (160 mg, 0.63 mmol, 1.0 equiv.) and water (0.42 g) is added. The mixture is stirred at ambient temperature for seven days, until it becomes homogeneous and dark brown. It is used without further treatment, with a metal content of 0.99%.

### Example 22: Synthesis of V*HS-(9aa) from VOSO₄ in a Two-Step One-Pot Fashion (V*HS-9a)

Into a round bottom flask, NaOAc (184 mg, 1.35 mmol, 2.2 equiv.), L-histidine (22 mg, 0.14 mmol, 0.2 equiv.), L-tryptophan (15 mg, 0.07 mmol, 0.1 equiv.), L-methionine (11 mg, 0.07 mmol, 0.1 equiv.), L-serine (7 mg, 0.07 mmol, 0.1 equiv.), L-glutamic acid (11 mg, 0.07 mmol, 0.1 equiv.), L-lysine (10 mg, 0.07 mmol, 0.1 equiv.), L-phenylalanine (12 mg, 0.07 mmol, 0.1 equiv.), L-cysteine (9 mg, 0.07 mmol, 0.1 equiv.), L-leucine (12 mg, 0.09 mmol, 0.15 equiv.), DMSO (2.28 g), and salicylaldehyde (86 mg, 0.7 mmol, 1.2 equiv.) are added and stirred for 30 minutes at ambient temperature. To the yellow mixture, VOSO₄ pentahydrate (155 mg, 0.61 mmol, 1.0 equiv.) and water (0.41 g) is added. The mixture is stirred at ambient temperature for seven days, until it becomes homogeneous and dark brown. It is used without further treatment, with a metal content of 0.97%.

### Example 23: Synthesis of V*mHS-His from VOSO₄ in a Two-Step One-Pot Fashion (V*mHS-His)

Into a round bottom flask, NaOAc (190 mg, 1.40 mmol, 2.3 equiv.), L-histidine (113 mg, 0.73 mmol, 1.2 equiv.), DMSO (2.12 g), and 2′-hydroxyacetophenone (98 mg, 0.72 mmol, 1.2 equiv.) are added and stirred for 30 minutes at ambient temperature. To the light yellow mixture, VOSO₄ pentahydrate (153 mg, 0.60 mmol, 1.0 equiv.) and water (0.40 g) is added. The mixture is stirred at ambient temperature over night, until it becomes homogeneous and dark green-brown. It is used without further treatment, with a metal content of 1.00%.

### Example 24: Synthesis of V*XJ from V-TS and XJ Prior to Making the Formulation (V*XJ)

Into a container for making test formulations, a solution of V-TS in DMSO (127 mg, 10.0 weight %) and a solution of XJ in ethyl acetate (225 mg, 5.9 weight %, 1.0 molar equivalents) are added. Upon mixing the two, the solution turns green. An alkyd formulation is added directly afterwards, followed by mixing everything in a speed-mixer.

### Example 25: Synthesis of V*HS-His with 1.2:0.9 Aldehyde: Histidine (V*HS-His K)

Into a round bottom flask, NaOAc (171 mg, 1.25 mmol, 2.4 equiv.), L-histidine (68 mg, 0.44 mmol, 0.9 equiv.), DMSO (1.89 g), and salicylaldehyde (77 mg, 0.63 mmol, 1.2 equiv.) are added and stirred for 30 minutes at ambient temperature. To the yellow mixture, V-TS (258 mg, 0.52 mmol, 1.0 equiv.) is added. The dark mixture is stirred at ambient temperature over night, until it becomes homogeneous. It is used without further treatment, with a metal content of 1.07%.

### Example 26: Synthesis of V*HS-His with 0.8:1.25 Aldehyde: Histidine (V*HS-His L)

Into a round bottom flask, NaOAc (171 mg, 1.25 mmol, 2.5 equiv.), L-histidine (98 mg, 0.63 mmol, 1.25 equiv.), DMSO (1.94 g), and salicylaldehyde (51 mg, 0.41 mmol, 0.82 equiv.) are added and stirred for 30 minutes at ambient temperature. To the yellow mixture, V-TS (252 mg, 0.50 mmol, 1.0 equiv.) is added. The dark mixture is stirred at ambient temperature over night, until it becomes homogeneous. It is used without further treatment, with a metal content of 1.05%.

### Example 27: Synthesis of V*HS-His with 2:1 Aldehyde: Histidine (V*HS-His M)

Into a round bottom flask, NaOAc (278 mg, 2.04 mmol, 3.0 equiv.), L-histidine (107 mg, 0.69 mmol, 1.0 equiv.), propylene glycol (2.27 g), and salicylaldehyde (172 mg, 1.41 mmol, 2.07 equiv.) are added and stirred for 30 minutes at ambient temperature. To the yellow mixture, V-TS (340 mg, 0.68 mmol, 1.0 equiv.) is added. The dark mixture is stirred at ambient temperature over night, until it becomes homogeneous. It is used without further treatment, with a metal content of 1.10%.

### Example 28: Synthesis of V*HS-His with 1:2 Aldehyde: Histidine (V*HS-His N)

Into a round bottom flask, NaOAc (276 mg, 2.03 mmol, 2.9 equiv.), L-histidine (211 mg, 1.36 mmol, 2.0 equiv.), propylene glycol (2.26 g), and salicylaldehyde (85 mg, 0.69 mmol, 1.0 equiv.) are added and stirred for 30 minutes at ambient temperature. To the yellow mixture, V-TS (347 mg, 0.70 mmol, 1.0 equiv.) is added. The dark mixture is stirred at ambient temperature over night, until it becomes homogeneous. It is used without further treatment, with a metal content of 1.11%.

### Example 29: Synthesis of V*HS-His in the Final Formulation (V*HS-His O)

Into a screw-cap plastic vial, L-histidine (12.6 mg, 0.08 mmol, 1.2 equiv.), Synaqua 2070 (10.06 g), salicylaldehyde (18 mg, 0.15 mmol, 2.2 equiv.) and a 38.2% solution of V-TS in DMSO (88 mg, 0.07 mmol, 1.0 equiv.) is added. The slightly yellow formulation is mixed in a speed-mixer at 2000 rpm for 6 minutes and stored at ambient temperature overnight. Before using it for a coating experiment, it is mixed once more for 2 minutes.

### Example #30: Synthesis of V*2Sal (V*2Sal)

Into a round bottom flask, NaOAc (184 mg, 1.35 mmol, 2.0 equiv.), propylene glycol (2.48 g), and salicylaldehyde (165 mg, 1.35 mmol, 2.0 equiv.) are added and stirred for 30 minutes at ambient temperature. To the yellow mixture, V-TS (340 mg, 0.68 mmol, 1.0 equiv.) is added. The dark mixture is stirred at ambient temperature overnight, until it becomes homogeneous. It is used without further treatment, with a metal content of 1.10%.

### Example #31: Synthesis of V*Sal (V*Sal)

Into a round bottom flask, NaOAc (93 mg, 0.68 mmol, 1.0 equiv.), propylene glycol (2.67 g), and salicylaldehyde (83 mg, 0.68 mmol, 1.0 equiv.) are added and stirred for 30 minutes at ambient temperature. To the yellow mixture, V-TS (338 mg, 0.68 mmol, 1.0 equiv.) is added. The dark mixture is stirred at ambient temperature overnight, until it becomes homogeneous. It is used without further treatment, with a metal content of 1.08%.

As clearly shown in the specification above, ligands, especially those of the type HS and HS-AA (as shown in Table IV) can be easily synthesized from two components. As shown in many of the examples above, the synthesis illustrates the use of two components (preferably in a 1:1 ratio) wherein the nitrogen and the Markush R group come from the amine component, whereas the phenol residue comes from the aldehyde/ketone residue. However, as illustrated in synthesized examples #25 to #28, it is possible to get good performance when the ratio of amine and aldehyde/ketone components are different from 1:1, e.g., a ratio of 1:2 (example #28) or 2:1 (example #29). In its broadest sense, the ratio of either the amine or the aldehyde/ketone components can each range from 0.01:3.0 up to 3.0:0.01.

In general, the invention solves the problems outlined previously in the following manner: (1) the new alkyd paint driers are based on the metal vanadium and do not contain cobalt; (2) they improve the hardness over the vanadium-drier V-TS, sometimes even higher hardness than cobalt-based driers; (3) they solve the issue of hardness development in V-TS, increasing the rate of hardness development, generally also increasing the dry time; (4) and they significantly improve adhesion after water resistance tests as compared to the vanadium-drier V-TS.

Specific experimental results illustrating these points are given below illustrating improved hardness, improved drying times and improved adhesion of the coating when compared to a coating prepared without the metal/non-symmetrical ligand complex.

TABLE XIII
results in the formulation vSAcc.

| | | | Dry times in | | | Hardness (König) in | | |
|---|---|---|---|---|---|---|---|---|
| | | | hours | | | seconds | | |
| Entry | Drier | MORS | ST | TF | DH | 1 d | 7 d | 14 d |
| 1 | BOC-1101 (formula III) | 0.001 | 0.3 | 4.8 | 24.0 | 15.4 | 21.0 | 24.3 |
| 2 | Deca Co 7a (formula IV) | 0.05 | 0.5 | 6.4 | 24.0 | 14.8 | 24.7 | 34.5 |
| 3 | V-TS (formula I) | 0.05 | 1.4 | 1.9 | 20.3 | 11.2 | 27.6 | 37.4 |
| 4 | V*8HQ B (Ex. 2) | 0.05 | 0.8 | 2.5 | 16.5 | 12.6 | 30.9 | 40.6 |
| 5 | V*8HQ A (Ex. 1) | 0.05 | 1.7 | 4.5 | 24.0 | 11.2 | 31.2 | 39.8 |

The results in Table XIII show that the V*8HQ-drier B shows the best dry time of all experiments (entry 4), and that both V*8HQ-drier A and B give the highest hardness of all driers after 14 days (entries 4 and 5). The two cases V*8HQ A and B also illustrate that different vanadium sources can be used to prepare these improved driers (here, V-TS and VO(acac)₂ respectively).

TABLE XIV
results in the formulation vSAcc.

| | | | Dry times | | | Hardness (König) | | |
|---|---|---|---|---|---|---|---|---|
| En- | | | in hours | | | in seconds | | |
| try | Drier | MORS | ST | TF | DH | 1 d | 7 d | 14 d |
| 1 | BOC-1101 | 0.001 | 0.7 | 6.4 | 24.0 | 13.3 | 19.7 | 24.7 |
| | (formula III) | | | | | | | |
| 2 | Deca Co 7a | 0.05 | 0.5 | 7.9 | 24.0 | 14.9 | 29.0 | 39.7 |
| | (formula IV) | | | | | | | |
| 3 | V-TS (Formula I) | 0.05 | 1.0 | 1.9 | 22.0 | 11.7 | 29.5 | 39.3 |
| 4 | V*HS-2 C (Ex. 6) | 0.05 | 1.6 | 3.7 | 20.0 | 14.0 | 30.3 | 41.6 |
| 5 | V*HS-2 A (Ex. 4) | 0.05 | 1.6 | 3.7 | 20.9 | 11.2 | 29.9 | 38.6 |
| 6 | V*HS-2 B (Ex. 5) | 0.05 | 1.8 | 4.3 | 19.7 | 14.0 | 33.6 | 43.5 |
| 7 | V*HS-His A (Ex. 8) | 0.05 | 0.9 | 3.7 | 16.5 | 15.0 | 34.5 | 43.0 |
| 8 | V*HS-His D (Ex. 11) | 0.05 | 1.0 | 3.7 | 24.0 | 11.3 | 28.0 | 37.3 |
| 9 | V*HS-His B (Ex. 9) | 0.05 | 1.3 | 4.3 | 21.3 | 11.2 | 30.4 | 38.3 |
| 10 | V*HS-His C (Ex. 10) | 0.05 | 1.5 | 5.0 | 18.0 | 12.6 | 36.4 | 42.1 |
| 11 | V*HS-His F (Ex. 13) | 0.05 | 0.9 | 4.4 | 19.2 | 16.4 | 40.2 | 46.8 |
| 12 | V*HS-His G2 (Ex. 15) | 0.05 | 0.8 | 4.7 | 20.9 | 18.2 | 42.0 | 44.9 |
| 13 | V*HS-His G (Ex. 14) | 0.05 | 0.9 | 4.7 | 17.6 | 16.8 | 40.2 | 45.4 |

The results in Table XIV show that the dry times are reduced when using the vanadium complexes, compared to BOC-1101 and the cobalt drier, but also compared with the vanadium drier V-TS. The V*HS-His drier is slightly superior to V*HS-2 (compare entries 6 and 7). Regarding hardness of the coating, both vanadium complexes are clearly superior to BOC-1101 and several examples also to the cobalt drier. The complex V*HS-His is again slightly superior to V*HS-2 (compare entry 6 with entries 11 to 13).

The results also support those the new vanadium catalysts can be synthesized in different ways with generally the same outcome. The VHS-2 driers can be synthesized from VO(acac)₂, Na₃VO₄ and V-TS, all showing essentially the same performance. The VHS-His driers can be synthesized in multiple ways from V₂O₅, VO(acac)₂, Na₃VO₄ and V-TS, by reaction with the preformed ligand HS-His as well as by synthesizing HS-His and the V-complex in a one-pot two-step fashion. Also, the ratio of ligand to vanadium can be varied between 2:1 and 1:1 without affecting the performance very much (compare entries 12 and 13).

TABLE XV
results in the formulation vSAcc.

| | | | Dry times | | | Hardness (König) | | |
|---|---|---|---|---|---|---|---|---|
| | | | in hours | | | in seconds | | |
| Entry | Drier | MORS | ST | TF | DH | 1 d | 7 d | 14 d |
| 1 | BOC-1101 (formula III) | 0.001 | 0.5 | 4.9 | 21.0 | 21.5 | 29.4 | 29.0 |
| 2 | Deca Co 7a (formula IV) | 0.05 | 0.5 | 8.8 | 24.0 | 22.4 | 40.2 | 45.3 |
| 3 | V-TS (Formula I) | 0.01 | 2.4 | 7.8 | 24.0 | 16.3 | 25.7 | 27.1 |
| 4 | V*XJ (Ex. 24) | 0.01 | 6.9 | 24.0 | 24.0 | 2.8 | 4.2 | 5.5 |
| 5 | V*HS-1 A (Ex. 3) | 0.01 | 2.4 | 11.6 | 21.0 | 12.6 | 25.2 | 25.7 |
| 6 | V*HS-2 C (Ex. 6) | 0.01 | 2.8 | 10.9 | 21.5 | 14.9 | 25.2 | 26.6 |
| 7 | V*HS-His A (Ex. 8) | 0.01 | 2.0 | 9.5 | 21.0 | 17.3 | 26.1 | 28.0 |
| 8 | V*8HQ B (Ex. 2) | 0.01 | 1.5 | 11.1 | 24.0 | 16.8 | 27.6 | 27.1 |

The results in Table XV show that the vanadium complexes with ligands of type HS-1, HS-2 and HS-His improve the dry time compared to the vanadium drier V-TS (compare entry 3 with entries 5-7). In contrast, the vanadium complex with the ligand XJ (of L_{O,N,N,O} type) shows a very poor dry time (entry 4). Regarding hardness, the results show that, at this concentration range, the vanadium driers show similar values compared to BOC. However, the complex with the ligand XJ (of L_{O,N,N,O} type) shows a very poor hardness (entry 4).

These results also show that the vanadium complexes with the new ligands of L_{O,N} and L_{O,N,O} type can also be used effectively at lower concentrations of 0.01% MORS.

TABLE XVI
results in the formulation vSAcc.

| | | | Dry times | | | Hardness (König) | | |
|---|---|---|---|---|---|---|---|---|
| | | | in hours | | | in seconds | | |
| Entry | Drier | MORS | ST | TF | DH | 1 d | 7 d | 14 d |
| 1 | BOC-1101 (formula III) | 0.001 | 0.5 | 6.0 | 24.0 | 24.3 | 30.0 | 30.4 |
| 2 | Deca Co 7a (formula IV) | 0.05 | 0.6 | 10.3 | 24.0 | 21.4 | 36.0 | 43.0 |
| 3 | V-TS (Formula I) | 0.05 | 1.3 | 2.0 | 19.5 | 14.5 | 32.3 | 41.2 |
| 4 | V*XJ (Ex. 24) | 0.05 | 16.3 | 24.0 | 24.0 | 4.6 | 6.5 | 8.4 |
| 5 | V*HS-1 A (Ex. 3) | 0.05 | 2.5 | 7.9 | 22.8 | 16.8 | 31.4 | 40.7 |
| 6 | V*HS-2 C (Ex. 6) | 0.05 | 2.9 | 6.0 | 19.0 | 20.1 | 37.0 | 45.4 |
| 7 | V*HS-His A (Ex. 8) | 0.05 | 1.0 | 5.5 | 14.3 | 21.0 | 36.0 | 46.2 |
| 8 | V*HS-His E (Ex. 12) | 0.05 | 1.8 | 3.8 | 13.3 | 21.0 | 37.4 | 45.4 |
| 9 | V*8HQ B (Ex. 2) | 0.05 | 0.9 | 4.1 | 24.0 | 19.1 | 36.4 | 43.0 |

The results in Table XVI show that the driers with the ligands of type HS-1, HS-2 and HS-His give good dry times compared to BOC and Co, and that most notably the ligand HS-His improves the dry times over the simple vanadium drier V-TS (compare entries 1-3 with 5-8). In contrast, the vanadium complex with the ligand XJ (of L_{O,N,N,O} type) shows a very poor dry time (entry 4). All ligands HS-1, HS-2, HS-His and 8HQ improve hardness compared with the vanadium drier V-TS after one day (compare entry 3 with entries 5-9), while the latter three ligands also improve hardness after seven and fourteen days. Notably, the ligands HS-2 and HS-His also give a higher hardness than the cobalt-drier after seven and fourteen days (compare entry 2 with entries 6-8). Once more, the complex with the ligand XJ (of L_{O,N,N,O} type) shows a very poor hardness (entry 4).

The results in Table XVI also show that the vanadium complexes with the ligands of the invention can also be prepared in the paint by adding a ligand to the paint that already contains a vanadium source (entry 8).

TABLE XVII
results in the formulation vSAcc.

| | | | Dry times | | | Hardness (König) | | |
|---|---|---|---|---|---|---|---|---|
| | | | in hours | | | in seconds | | |
| Entry | Drier | MORS | ST | TF | DH | 1 d | 7 d | 21 d |
| 1 | BOC-1101 | 0.001 | 0.5 | 5.0 | 24.0 | 21.0 | 26.6 | 29.9 |
| | (formula III) | | | | | | | |
| 2 | Deca Co 7a | 0.05 | 0.5 | 7.4 | 24.0 | 17.7 | 34.5 | 50.9 |
| | (formula IV) | | | | | | | |
| 3 | V-TS (formula I) | 0.05 | 1.1 | 1.8 | 24.0 | 16.8 | 30.3 | 45.3 |
| 4 | V*HS-His A (Ex. 8) | 0.05 | 1.6 | 3.4 | 14.5 | 18.7 | 36.4 | 50.4 |
| 5 | V*HS-His H (Ex. 16) | 0.05 | 1.0 | 3.9 | 19.3 | 19.6 | 35.0 | 53.8 |
| 6 | V*HS-Trp (Ex. 20) | 0.05 | 1.0 | 3.1 | 24.0 | 21.0 | 40.7 | 54.2 |
| 7 | V*HS-Ser (Ex. 20) | 0.05 | 0.9 | 5.0 | 24.0 | 20.5 | 36.0 | 53.7 |
| 8 | V*HS-Met (Ex. 20) | 0.05 | 0.9 | 4.4 | 24.0 | 20.1 | 37.8 | 53.3 |
| 9 | V*HS-Asp (Ex. 20) | 0.05 | 0.6 | 3.4 | 24.0 | 16.8 | 32.7 | 50.5 |
| 10 | V*HS-Gly (Ex. 20) | 0.05 | 0.9 | 4.1 | 23.0 | 17.8 | 35.5 | 53.3 |
| 11 | V*HS-His G (Ex. 14) | 0.05 | 1.0 | 4.4 | 14.3 | 21.0 | 33.6 | 53.3 |
| 12 | V*HS-His D (Ex. 11) | 0.05 | 0.9 | 3.8 | 18.0 | 16.8 | 33.6 | 51.4 |

The results in Table XVII show that all driers based on the ligand HS-His display a significantly improved dry time (entries 4, 5, 11, 12). This also shows that the drier V*HS-His can be synthesized in different ways, namely starting from different V-sources (V-TS, Na₃VO₄ and VO(acac)₂) and using different methods of synthesis (mixing the synthesized ligand and V-source in the container prior to adding the formulation, making a stock solution of the drier by mixing the synthesized ligand and V-source well in advance, and synthesizing the drier solution in a multi-component two-step one-pot fashion).

The results in Table XVII also show that all driers of type V*HS-AA display an improved hardness development over BOC-1101, the vanadium drier V-TS, and in several cases also over the cobalt drier. Notable cases are V*HS-Trp and V*HS-His which reach the same hardness as BOC-1101 after one day (compare entries 1, 6 and 11), as well as V*HS-His, V*HS-Trp, V*HS-Met and V*HS-Gly, which exceed the hardness of the cobalt drier after seven days (compare entries 2, 4, 5, 6, 7, 8 and 10).

TABLE XVIII
results in the formulation vSAcc.

| | | | Dry times | | | Hardness (König) | | |
|---|---|---|---|---|---|---|---|---|
| | | | in hours | | | in seconds | | |
| Entry | Drier | MORS | ST | TF | DH | 1 d | 7 d | 21 d |
| 1 | BOC-1101 | 0.001 | 0.5 | 5.0 | 19.3 | 18.2 | 23.3 | 29.0 |
| | (formula III) | | | | | | | |
| 2 | Deca Co 7a | 0.05 | 0.5 | 8.5 | 24.0 | 22.9 | 38.4 | 52.4 |
| | (formula IV) | | | | | | | |
| 3 | V-TS (formula I) | 0.05 | 1.4 | 5.4 | 13.4 | 16.3 | 31.3 | 48.6 |
| 4 | V*HS-Glu (Ex. 20) | 0.05 | 1.0 | 4.3 | 24.0 | 22.9 | 38.4 | 56.6 |
| 5 | V*HS-Lys (Ex. 20) | 0.05 | 1.0 | 3.6 | 24.0 | 24.3 | 40.7 | 55.6 |
| 6 | V*HS-Tyr (Ex. 20) | 0.05 | 1.1 | 3.4 | 24.0 | 21.9 | 36.4 | 52.3 |
| 7 | V*HS-Phe (Ex. 20) | 0.05 | 0.9 | 4.4 | 24.0 | 22.9 | 40.7 | 56.6 |
| 8 | V*HS-Asn (Ex. 20) | 0.05 | 1.3 | 4.1 | 24.0 | 20.5 | 35.5 | 54.2 |

The results in Table XVIII show that all driers of type VHS-AA display an improved hardness development over BOC-1101, the simple vanadium drier V-TS, and in several cases also over the cobalt drier. Notable cases are V*HS-Glu, VHS-Lys and V*HS-Phe, which show a higher or equal hardness after one day compared with both BOC-1101 and the cobalt drier (compare entries 1, 2, 4, 5 and 7), as well as V*HS-Glu, V*HS-Lys, V*HS-Phe and V*HS-Asn, which exceed the hardness of the cobalt drier after 21 days (compare entries 2, 4, 5, 7 and 8).

TABLE XIX
results in the formulation vSAcc.

| | | | Dry times | | | Hardness (König) | |
|---|---|---|---|---|---|---|---|
| | | | in hours | | | in s | |
| Entry | Drier | MORS | ST | TF | DH | 1 d | 21 d |
| 1 | BOC-1101 | 0.001 | 0.4 | 5.0 | 24.0 | 18.7 | 28.0 |
| | (formula III) | | | | | | |
| 2 | Deca Co 7a | 0.05 | 0.5 | 6.6 | 24.0 | 21.0 | 44.9 |
| | (formula IV) | | | | | | |
| 3 | V-TS (formula I) | 0.05 | 1.3 | 6.1 | 21.5 | 14.9 | 43.5 |
| 4 | V*HS-Cystine | 0.05 | 0.8 | 4.5 | 17.0 | 14.9 | 43.9 |
| | (Ex. 20) | | | | | | |
| 5 | V*HS-Cys (Ex. 20) | 0.05 | 0.3 | 2.4 | 24.0 | 22.4 | 50.9 |
| 6 | V*HS-Arg (Ex. 20) | 0.05 | 0.9 | 3.8 | 24.0 | 19.6 | 51.9 |
| 7 | V*HS-Leu (Ex. 20) | 0.05 | 0.8 | 7.9 | 24.0 | 22.4 | 54.2 |
| 8 | V*HS-Pro (Ex. 20) | 0.05 | 0.6 | 6.8 | 22.3 | 12.6 | 46.7 |

The results in Table XIX show that VHS-Cystine leads to a significantly improved dry time over the reference driers BOC-1101, Co and V-TS (compare entries 1, 2, 3 and 5). It also shows that all driers of type V*HS-AA display an improved hardness development over BOC-1101, the simple vanadium drier V-TS, and in several cases also over the cobalt drier. Notable cases are V*HS-Cys, V*HS-Arg and VHS-Leu, which show higher hardness after one and 21 days over BOC, V-TS and cobalt, respectively (compare entries 1, 2, 3, 5, 6 and 7). Also V*HS-Pro exceed the hardness of the three reference driers after 21 days (compare entries 1, 2, 3 and 8).

TABLE XX
results in the formulation vSAcc.

| | | | Dry times | | | Hardness (König) | | |
|---|---|---|---|---|---|---|---|---|
| | | | in hours | | | in seconds | | |
| Entry | Drier | MORS | ST | TF | DH | 1 d | 7 d | 14 d |
| 1 | BOC-1101 (formula III) | 0.001 | 0.5 | 4.4 | 24.0 | 21.4 | 27.1 | 27.6 |
| 2 | Deca Co 7a (formula IV) | 0.05 | 0.5 | 6.5 | 24.0 | 22.4 | 32.7 | 39.2 |
| 3 | V-TS (Formula I) | 0.05 | 1.3 | 3.4 | 22.6 | 14.5 | 29.9 | 37.4 |
| 4 | V*HS-His I (Ex. 17) | 0.05 | 0.5 | 3.1 | 20.6 | 23.4 | 36.0 | 43.9 |
| 5 | V*HS-HW (Ex. 21) | 0.05 | 0.8 | 3.8 | 24.0 | 21.9 | 38.4 | 43.1 |
| 6 | V*HS-9a (Ex. 22) | 0.05 | 0.5 | 3.1 | 24.0 | 25.7 | 42.0 | 49.6 |
| 7 | V*HS-His 12 (Ex. 18) | 0.05 | 1.0 | 4.9 | 7.9 | 16.4 | 33.2 | 41.3 |
| 8 | V*HS-His J (Ex. 19) | 0.05 | 0.4 | 3.4 | 20.5 | 23.4 | 39.7 | 45.9 |
| 9 | V*mHS-His (Ex. 23) | 0.05 | 1.1 | 11.5 | 21.6 | 12.6 | 33.1 | 43.4 |
| 10 | V*HS-His J (Ex. 19) | 0.15 | 0.3 | 4.1 | 14.3 | 23.8 | 39.3 | 45.9 |
| 11 | BOC + V*HS-His J (Ex. 19) | 0.05 | 0.5 | 3.9 | 24.0 | 25.7 | 38.0 | 48.7 |
| 12 | V*HS-His J (Ex. 19) + Zr | 0.05 | 0.9 | 3.0 | 24.0 | 24.6 | 39.2 | 45.1 |

The results in Table XX show that especially the drier V*HS-His improves the dry time over the plain vanadium drier V-TS (compare entry 3 with entries 4, 7, 8 and 10). An especially good dry-hard time is achieved with the drier VHS-His 12, which only has 0.6 equivalents of ligand to 1.0 equivalents of vanadium (entry 7). This also shows that an excess of vanadium over the ligand provides a significantly improved drier. Furthermore, the comparison of V*HS-His I and V*HS-His J shows that both vanadium-precursors VOSO₄ and VO(acac)₂ can be used to synthesize the drier V*HS-His (entries 4 and 8). An improved dry time was also achieved with V*mHS-His (entry 9), showing that the ketone 2′-hydroxyacetophenone can also be used instead of salicylaldehyde to synthesize improved driers.

The hardness results in Table XX also show that all new driers of this invention give improved results over the plain vanadium drier V-TS. Mixtures of ligands can also be used, as is evident from V*HS-HW and VHS-9a, the latter giving the highest hardness values in this series after 1, 7 and 14 days (compare entries 3, 5 and 6). The drier V*mHS-His, derived from 2′-hydroxyacetophenone instead of salicylaldehyde, shows a weaker hardness after 1 day, compared with V-TS, but overtaking V-TS after 7 and 14 days (compare entries 3 and 9).

In addition, Table XX shows that the new driers can be successfully combined with other primary and secondary driers. The primary drier BOC-1101 can be combined with V*HS-His, for example, giving an improved hardness after one and 14 days, compared with BOC-1101 and V*HS-His alone (compare entries 1, 8 and 11; BOC-1101 being used at the recommend dosage of 0.001% MORS). The addition of the secondary drier Octa Soligen Zirconium 10 aqua also provides an improved hardness after 1 day (compare entries 8 and 12; the secondary drier being used at the recommend dosage of 0.10% MORS).

TABLE XXI
results in the formulation 11Ya-wp.

| | | | Dry | | | | |
|---|---|---|---|---|---|---|---|
| | | | time | Hardness (König) | | | |
| | | | (d) | in seconds | | | |
| Entry | Drier | MORS | DH | 1 d | 7 d | 14 d | Adh. |
| 1 | BOC-1101 (formula III) | 0.001 | >14 | 8.8 | 6.9 | 9.8 | 0 B |
| 2 | WD016 | 0.18 | 3 | 7.0 | 12.1 | 15.9 | 4 B |
| 3 | V-TS (formula I) | 0.05 | 10 | 5.6 | 7.4 | 13.1 | 3 B |
| 4 | V*HS-His H (Ex. 16) | 0.05 | 3 | 8.8 | 11.2 | 17.3 | 1 B |
| 5 | V*HS-Trp (Ex. 20) | 0.05 | 3 | 10.3 | 14.0 | 19.6 | 2 B |
| 6 | V*HS-Ser (Ex. 20) | 0.05 | 7 | 8.4 | 10.7 | 15.4 | 1 B |
| 7 | V*HS-Met (Ex. 20) | 0.05 | 8 | 9.8 | 11.2 | 16.8 | 1 B |
| 8 | V*HS-Asp (Ex. 20) | 0.05 | 8 | 7.7 | 8.8 | 13.5 | 1 B |
| 9 | V*HS-Gly (Ex. 20) | 0.05 | 8 | 7.0 | 8.4 | 13.5 | 1 B |
| 10 | V*HS-Glu (Ex. 20) | 0.05 | 9 | 7.0 | 8.4 | 12.6 | 1 B |
| 11 | V*HS-Lys (Ex. 20) | 0.05 | 8 | 7.5 | 9.8 | 15.0 | 2 B |
| 12 | V*HS-Tyr (Ex. 20) | 0.05 | 6 | 8.4 | 9.8 | 14.5 | 1 B |
| 13 | V*HS-Phe (Ex. 20) | 0.05 | 6 | 8.4 | 11.2 | 15.9 | 3 B |
| 14 | V*HS-Asn (Ex. 20) | 0.05 | 7 | 7.0 | 8.9 | 14.0 | 1 B |
| 15 | V*HS-Cystine (Ex. 20) | 0.05 | 7 | 7.0 | 8.3 | 13.5 | 1 B |
| 16 | V*HS-Cys (Ex. 20) | 0.05 | 7 | 7.0 | 8.9 | 14.0 | 4 B |
| 17 | V*HS-Arg (Ex. 20) | 0.05 | 8 | 8.4 | 9.8 | 15.4 | 3 B |
| 18 | V*HS-Leu (Ex. 20) | 0.05 | 7 | 8.3 | 10.7 | 14.5 | 2 B |
| 19 | V*HS-Pro (Ex. 20) | 0.05 | 8 | 7.0 | 8.4 | 13.5 | 1 B |

The results in Table XXI show that the driers based on the ligands HS-His and HS-Trp display a very good dry time equal to the cobalt-based drier WD016 (entries 2, 4 and 5), and that in general all driers V*HS-AA show an improved dry time over BOC-1101 and the reference vanadium-drier V-TS (compare entries 1 and 3 with 4-19). The results also show a significantly improved hardness development with the VHS-AA driers. Notable cases are V*HS-His, V*HS-Trp and V*HS-Met, which display a higher or equal hardness after one day as the best reference drier BOC-1101 (compare entries 1, 4, 5 and 7), and V*HS-His, V*HS-Trp and V*HS-Met, which after 14 days show a higher hardness than all three reference driers (compare entries 1-3 with 4, 5 and 7).

The data of Table XXI shows that all of the V*HS-AA driers show an improved adhesion compared with BOC-1101, and a few show a similar or equal adhesion as the reference driers WD016 and V-TS. Notable cases are V*HS-Phe, V*HS-Cys and V*HS-Arg (entries 13, 16 and 17).

TABLE XXII
results in a solventborne alkyd (WorléeKyd S351)

| | | | Dry times | | | Hardness (König) | | |
|---|---|---|---|---|---|---|---|---|
| | | | in hours | | | in seconds | | |
| Entry | Drier | MORS | ST | TF | DH | 1 d | 7 d | 14 d |
| 2 | Deca Co 7a (formula IV) | 0.05 | 1.6 | 7.4 | 13.9 | 24.3 | 35.6 | 48.6 |
| 3 | V-TS (formula I) | 0.05 | 0.5 | 1.8 | 5.6 | 17.3 | 28.1 | 38.9 |
| 4 | V*HS-His H (Ex. 16) | 0.05 | 1.8 | 8.5 | 12.5 | 15.4 | 24.4 | 32.2 |
| 5 | V*HS-Trp (Ex. 20) | 0.05 | 1.5 | 3.3 | 5.8 | 17.4 | 25.8 | 34.6 |
| 6 | V*HS-Leu (Ex. 20) | 0.05 | 1.5 | 3.4 | 6.5 | 18.3 | 28.1 | 38.3 |
| 7 | V*mHS-His (Ex. 23) | 0.05 | 2.1 | 16.5 | 18.5 | 8.4 | 15.5 | 21.1 |
| 8 | V*HS-2 A (Ex. 4) | 0.05 | 1.1 | 5.0 | 12.0 | 12.6 | 28.1 | 41.1 |
| 9 | V*8HQ B (Ex. 2) | 0.05 | 0.8 | 3.5 | 6.3 | 17.8 | 26.7 | 38.4 |

The results in Table XXII show that the driers of the present invention can also be used successfully in the curing of solventborne alkyds. Many ligands make the dry time slightly worse as compared with the reference drier V-TS, with the exception of V*HS-Trp (compare entries 3 and 5). However, some improvement in hardness is seen after one day with V*HS-Trp, V*HS-Leu and V*8HQ (compare entries 3 with 5, 6 and 9) and after 14 days with V*HS-2 (compare entries 3 and 8).

TABLE XXIII
results in the formulation 11Ya-cc.

| | | | Dry | | | |
|---|---|---|---|---|---|---|
| | | | time | Hardness (König) | | |
| | | | (d) | in seconds | | |
| Entry | Drier | MORS | DH | 1 d | 7 d | 14 d |
| 1 | BOC-1101 (formula III) | 0.0020 | 7 | 7.5 | 7.6 | 7.5 |
| 2 | WD016 | 0.1786 | 3 | 9.3 | 17.3 | 16.0 |
| 3 | V-TS (formula I) | 0.0599 | 6 | 6.2 | 14.6 | 16.0 |
| 4 | V*HS-His K (Ex. 25) | 0.0601 | 3 | 9.7 | 15.4 | 19.6 |
| 5 | V*HS-His L (Ex. 26) | 0.0600 | 1.5 | 9.4 | 15.5 | 18.3 |

The results in Table XXIII show that the ligand can also be synthesized from the two components (aldehyde and histidine in this case) in different proportions, and that the resulting V-drier is still superior to the parent drier V-TS (compare entries 3-5). Regardless of whether the aldehyde or the amine component is in slight excess, the drier shows superior dry time and hardness.

### Aldehyde Only Formulation:

TABLE XXIV
results in the formulation 11Ya-wp.

| | | | Dry | | | |
|---|---|---|---|---|---|---|
| | | | time | Hardness (König) | | |
| | | | (d) | in seconds | | |
| Entry | Drier | MORS | DH | 1 d | 7 d | 14 d |
| 1 | BOC-1101 (formula III) | 0.002 | 10.0 | 8.4 | 11.3 | 12.7 |
| 2 | WD016 | 0.175 | 2.5 | 6.4 | 15.4 | 18.2 |
| 3 | V-TS (formula I) | 0.090 | 7.0 | 6.1 | 13.2 | 19.2 |
| 4 | V*HS-His M (Ex. 27) | 0.175 | 2.0 | 9.3 | 13.6 | 19.2 |
| 5 | V*HS-His N (Ex. 28) | 0.175 | 6.0 | 10.2 | 16.8 | 21.9 |
| 6 | V*2Sal (Ex. 30) | 0.090 | 6.0 | 8.3 | 15.9 | 21.0 |
| 7 | V*Sal (Ex. 31) | 0.175 | 2.5 | 8.9 | 12.7 | 17.4 |

The results in Table XXIV show that the ligand can also be synthesized from the two components (aldehyde and histidine in this case) in different proportions, and that the resulting V-drier is still superior to the parent drier V-TS (compare entries 3, 4 and 5). Regardless of whether the aldehyde and the amine component, respectively, is in twofold excess, the drier shows superior dry time and hardness. If the amine component is in twofold excess over vanadium and the aldehyde, the drier shows the highest hardness after 1, 7 and 14 days in this formulation (entry 5). The results in this table also show that these drier solutions are not limited to DMSO as solvent but can also be prepared in propylene glycol (see examples #27 & #28).

It should also be noted that examples #30 and #31, corresponding to entries 6 and 7, demonstrate that it is possible to leave out one of the components used in forming the L_{ONO} compound, and still produce an effective drier. Therefore, in this particular instance, the ratio of either the amine or the aldehyde/ketone components can each range from 0-3:1.

### L_{ON} Ligands:

Surprisingly, it was discovered that simplified versions of the ligands described above improved the performance of simple vanadium driers, too. Specifically, we found that α-amino acids could also be used successfully. These natural compounds also fall under the definition of being non-symmetrical L_{ON}-type ligands. While generally not giving the same levels of improved hardness as the L_{ONO}-type ligands used above, we still observed increased hardness in some cases. Moreover, we could observe improved dry times and most of all an improved adhesion after soaking the coatings in water (water resistance test).

In general, the alkyd paint driers based on the combination of vanadium drier V-TS and amino acids addressed the issue of adhesion performance after water resistance tests over that of V-TS and demonstrated how performance is improved, also resulting in higher hardness and better dry times as compared to the vanadium drier V-TS; and the combination of amino acids with the other metal precursors like Fe salts and Mn salts showed better dry times, hardness, and better adhesion as compared to the precursors.

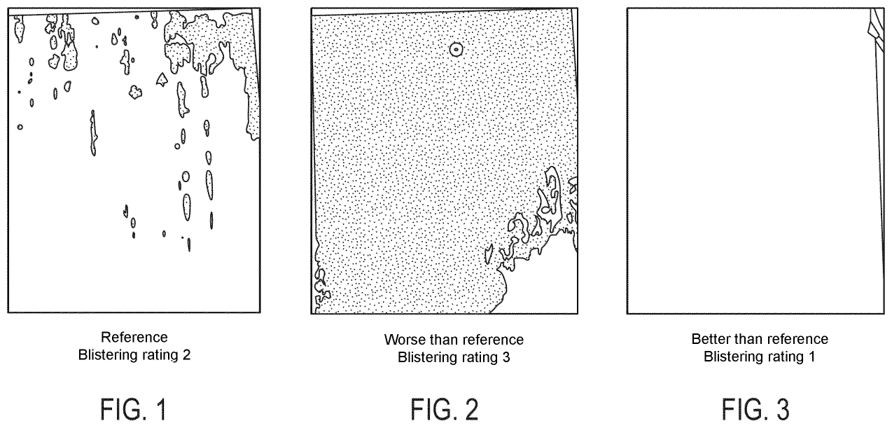

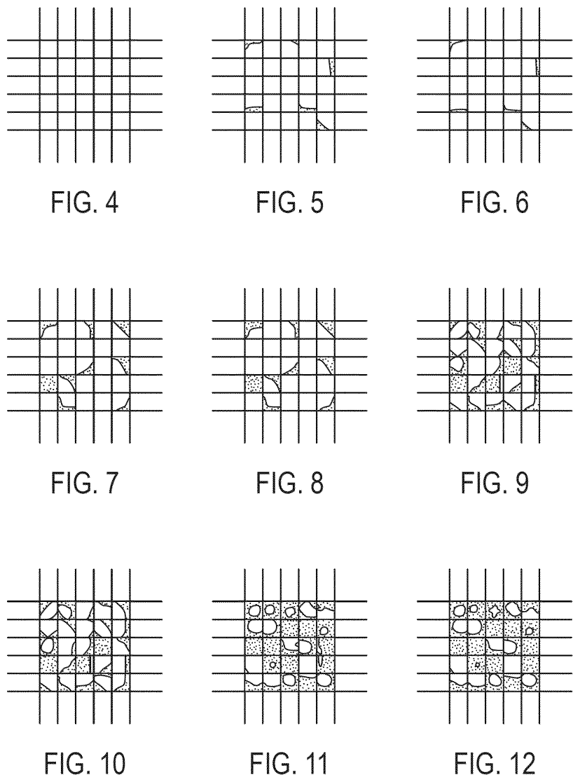

Specific experimental results illustrating these points are given in the accompanying FIGS. 1-12, illustrating reduced blistering and improved adhesion of the coating when compared to a coating prepared without V-TS.

TABLE XXV
Influence of amino acids in adhesion in the formulation Beckosol AQ 206-cc

| | | | Dry times in | | | Hardness (König) | | | | |
|---|---|---|---|---|---|---|---|---|---|---|
| | | | hours | | | in seconds | | | | |
| Entry | Drier | MORS | ST | TF | DH | 1 d | 7 d | 14 d | Blistering | Adhesion |
| 1 | V-TS | 0.05 | 1.1 | 5.2 | 24.0 | 11.5 | 23.8 | 30.9 | 2 | 0 B |
| 2 | V-TS +Trp | 0.05 | 0.5 | 2.5 | 24.0 | 12.6 | 23.1 | 30.9 | 1 | 4 B |
| 3 | V-TS + His | 0.05 | 0.6 | 1.4 | 24.0 | 14.0 | 21.0 | 28.0 | 2 | 0 B |
| 4 | V-TS + CysD | 0.05 | 0.9 | 6.3 | 24.0 | 11.2 | 25.2 | 32.3 | 2 | 0 B |
| 5 | V-TS + Met | 0.05 | 1.3 | 4.5 | 24.0 | 12.6 | 25.3 | 35.1 | 2 | 0 B |
| 6 | V-TS + Cys | 0.05 | 0.7 | 3.0 | 24.0 | 12.3 | 25.2 | 33.7 | 2 | 0 B |
| 7 | V-TS + Asp | 0.05 | 2.5 | 9.8 | 24.0 | 9.8 | 25.3 | 35.1 | 3 | 0 B |
| 8 | V-TS + Glu | 0.05 | 2.5 | 9.9 | 24.0 | 12.6 | 26.6 | 37.2 | 3 | 0 B |
| 9 | V-TS + Lys | 0.05 | 1.0 | 3.1 | 24.0 | 9.8 | 22.4 | 28.1 | 3 | 0 B |
| 10 | V-TS + Tyr | 0.05 | 1.0 | 5.0 | 24.0 | 9.8 | 25.3 | 30.9 | 3 | 0 B |
| 11 | V-TS + Phe | 0.05 | 0.5 | 2.7 | 24.0 | 15.4 | 25.9 | 32.3 | 2 | 0 B |
| 12 | V-TS + Arg | 0.05 | 0.5 | 3.6 | 24.0 | 9.8 | 22.5 | 28.0 | 3 | 0 B |
| 13 | V-TS + Leu | 0.05 | 1.1 | 2.7 | 24.0 | 14.0 | 24.5 | 30.8 | 1 | 0 B |
| 14 | V-TS + Pro | 0.05 | 1.1 | 3.1 | 24.0 | 8.4 | 22.5 | 29.5 | 1 | 0 B |
| 15 | V-TS + Asp | 0.05 | 1.0 | 4.2 | 24.0 | 11.2 | 23.8 | 28.1 | 2 | 0 B |
| 16 | V-TS + Gly | 0.05 | 1.2 | 4.1 | 24.0 | 9.8 | 22.4 | 29.5 | 1 | 0 B |
| 17 | V-TS + Ser | 0.05 | 1.3 | 3.5 | 24.0 | 12.6 | 28.1 | 36.5 | 1 | 0 B |

All the amino acids listed under materials were tested in combination with V-TS in Beckosol AQ 206-clear coat as a binder and are displayed in Table XXVI.

V-TS+Trp shows the best adhesion of all the amino acid ligands tested (entry 2) and others are showing very poor performance in adhesion. The overall performance of amino acids with V-TS in the water resistance test/blistering was average, while a few showed similar performance (compare entry 1 and 3-6, 11 and 15), and notably, some amino acid combinations showed a superior performance than the reference V-TS drier (compare entry 1 and 2, 13, 14, 16 and 17).

TABLE XXVI
Influence of amino acids in adhesion in the formulation 11ya-WP

| | | | Dry time | Hardness (König) | | | |
|---|---|---|---|---|---|---|---|
| En- | | | in days | in seconds | | | Adhe- |
| try | Drier | MORS | DH | 1 d | 7 d | 14 d | sion |
| 1 | V-TS | 0.05 | 14.0 | 7.0 | 9.7 | 14.0 | 1 B |
| 2 | V-TS + Trp | 0.05 | 14.0 | 7.0 | 9.8 | 14.0 | 4 B |
| 3 | V-TS + Tyr | 0.05 | 14.0 | 7.0 | 9.8 | 14.0 | 4 B |
| 4 | V-TS + Phe | 0.05 | 9.0 | 7.0 | 12.6 | 14.0 | 4 B |
| 5 | V-TS + Arg | 0.05 | 9.0 | 7.0 | 9.8 | 14.0 | 4 B |
| 6 | V-TS + Leu | 0.05 | 14.0 | 7.0 | 11.2 | 15.4 | 4 B |
| 7 | V-TS + Lys | 0.05 | 14.0 | 7.0 | 9.8 | 14.0 | 3 B |
| 8 | V-TS + CysD | 0.05 | 9.0 | 7.0 | 9.8 | 15.0 | 1 B |
| 9 | V-TS + Cys | 0.05 | 9.0 | 7.0 | 9.8 | 12.6 | 1 B |
| 10 | V-TS + Glu | 0.05 | 14.0 | 7.0 | 9.8 | 12.6 | 1 B |
| 11 | V-TS + Pro | 0.05 | 14.0 | 7.0 | 9.8 | 14.0 | 1 B |
| 12 | V-TS + His | 0.05 | 14.0 | 7.0 | 8.4 | 12.7 | 0 B |
| 13 | V-TS + Met | 0.05 | 14.0 | 7.0 | 9.8 | 15.5 | 0 B |
| 14 | V-TS + Asp | 0.05 | 9.0 | 7.0 | 9.8 | 13.5 | 0 B |
| 15 | V-TS + Asn | 0.05 | 14.0 | 7.0 | 9.8 | 14.0 | 0 B |
| 16 | V-TS + Gly | 0.05 | 14.0 | 7.0 | 9.8 | 12.6 | 0 B |
| 17 | V-TS + Ser | 0.05 | 14.0 | 7.0 | 11.2 | 14.0 | 0 B |
| 18 | Fe | 0.05 | >14 | 8.4 | 8.3 | 8.3 | 3 B |
| 19 | Fe + Phe | 0.05 | >14 | 7.7 | 6.9 | 9.8 | 4 B |
| 20 | Fe + Leu | 0.05 | >14 | 6.9 | 6.9 | 9.8 | 4 B |
| 21 | Fe + Ser | 0.05 | >14 | 2.8 | 8.4 | 8.4 | 4 B |
| 22 | Mn | 0.02 | 6 | 9.7 | 14.0 | 16.8 | 2 B |
| 23 | Mn + Ser | 0.02 | 9.0 | 11.1 | 15.4 | 19.6 | 4 B |
| 24 | Mn + Leu | 0.02 | 9.0 | 11.1 | 15.5 | 18.3 | 3 B |
| 25 | Mn + Trp | 0.02 | 6.0 | 12.6 | 16.8 | 18.3 | 3 B |

All the amino acids listed under materials were tested in combination with V-TS, Fe and Mn in 211Y-white pigmented as a binder and only the significant results with Fe and Mn are displayed in Table XXVI.

The results in Table XXVI show that the driers based on the amino acids V-Ts+Trp, V-Ts+Tyr, V-Ts+Phe, V-Ts+Arg, and V-Ts+Leu showed the best adhesion compared to the reference V-Ts drier (entry 2-6). Especially, V-Ts+Arg showed improved dry time-dried in 9 days-similar 14 days hardness, and yellowing compared to the reference V-TS but with an improved adhesion (entry 1, 5). No blistering was observed in any of the cases.

The results in Table XXVI (entry 18-24) display the positive influence of amino acids when combined with other metals like Fe and Mn. Noteworthy cases are Fe+Phe, Fe+Leu and Fe+Ser which showed better adhesion when compared to the reference compound (entry 18-21). Similarly, Mn+Ser, Mn+Leu and Mn+Trp showed better hardness on all the three days measured, and notably, Mn+Ser showed improvement in adhesion and less yellowing compared to the reference drier Mn (entry 22, 23).

TABLE XXVII
Influence of amino acids in hardness development
in the formulation vSAcc

| | | | Dry times | | | Hardness (König) | | |
|---|---|---|---|---|---|---|---|---|
| | | | in hours | | | in seconds | | |
| Entry | Drier | MORS | ST | TF | DH | 1 d | 7 d | 14 d |
| 1 | V-TS | 0.05 | 1.6 | 5.5 | 15.0 | 22.8 | 36.8 | 42.3 |
| 2 | V-TS + Ser | 0.05 | 1.5 | 6.3 | 18.0 | 26.7 | 40.7 | 46.7 |
| 3 | V-TS + Cys | 0.05 | 0.6 | 4.6 | 14.6 | 22.4 | 39.2 | 46.2 |
| 4 | V-TS + Leu | 0.05 | 1.8 | 4.5 | 24.0 | 23.5 | 37.9 | 45.9 |
| 5 | V-TS + Gly | 0.05 | 1.5 | 7.3 | 22.8 | 22.4 | 38.6 | 45.4 |
| 6 | V-TS + Pro | 0.05 | 1.7 | 4.8 | 24.0 | 22.4 | 36.5 | 44.6 |
| 7 | V-TS + Tyr | 0.05 | 1.6 | 4.8 | 24.0 | 21.0 | 36.9 | 43.5 |
| 8 | V-TS + Glu | 0.05 | 1.9 | 6.7 | 24.0 | 21.0 | 36.4 | 43.5 |
| 9 | V-TS + CysD | 0.05 | 1.3 | 3.8 | 10.7 | 19.6 | 36.4 | 43.0 |
| 10 | V-TS + Asp | 0.05 | 1.7 | 9.7 | 24.0 | 19.7 | 36.5 | 42.5 |
| 11 | V-TS + Phe | 0.05 | 1.4 | 3.6 | 11.6 | 22.9 | 36.5 | 42.4 |
| 12 | V-TS + His | 0.05 | 1.6 | 8.5 | 13.2 | 17.2 | 34.2 | 42.1 |
| 13 | V-TS + Trp | 0.05 | 1.2 | 5.2 | 24.0 | 21.0 | 36.0 | 42.1 |
| 14 | V-TS + Lys | 0.05 | 1.5 | 4.9 | 24.0 | 19.6 | 34.6 | 42.0 |
| 15 | V-TS + Asn | 0.05 | 1.1 | 9.0 | 24.0 | 15.4 | 33.7 | 40.6 |
| 16 | V-TS + Met | 0.05 | 1.5 | 12.8 | 22.5 | 14.0 | 35.1 | 39.3 |
| 17 | V-TS + Arg | 0.05 | 1.5 | 6.4 | 10.3 | 16.1 | 28.0 | 34.8 |
| 18 | Fe | 0.05 | 3.8 | 18.3 | 24.0 | 16.8 | 29.4 | 32.2 |
| 19 | Fe + Asp | 0.05 | 2.5 | 13.3 | 21.0 | 25.2 | 33.7 | 36.0 |
| 20 | Fe + His | 0.05 | 1.5 | 4.0 | 8.0 | 26.7 | 32.3 | 35.1 |
| 21 | Fe + Ser | 0.05 | 1.7 | 4.8 | 12.0 | 26.7 | 32.3 | 35.0 |
| 22 | Mn | 0.02 | 5.5 | 25.0 | 24.0 | 13.1 | 26.7 | 29.4 |
| 23 | Mn + His | 0.02 | 2.8 | 8.7 | 18.3 | 22.1 | 29.4 | 32.3 |

All the amino acids listed under materials were tested in combination with V-TS, Fe and Mn in Synaqua 4804-clear coat as a binder and only the significant results with Fe and Mn are displayed in Table XXVII.

The results in Table XXVII show that the combination of V-TS and different amino acids improved the dry times and hardness over the reference driers V-TS, Fe, and Mn. The combination of V-TS+Ser, V-TS+Csy, V-TS+Leu, and V-TS+Gly display an improved hardness over the vanadium drier V-TS (entry 1-5). Notably, V-TS+CysD, V-TS+Phe, V-TS+His improved the dry times compared to the reference dries V-TS (entry 1, 9, 11, and 12).

The versatility of the amino acids is evident by the increase in the hardness when combined with other metals (entry 18-23). Its noteworthy that Fe+His showed a significant improvement in dry time and hardness measured after 1 day and better hardness after 7 and 14 days as well (compare entry 18 and 20), and the same outcome was observed with Mn+His drier (compare entry 22 and 23).

TABLE XXVIII
results in the formulation Synaqua 2070.

| | | | Dry | | | |
|---|---|---|---|---|---|---|
| | | | time | Hardness (König) | | |
| | | | (h) | in seconds | | |
| Entry | Drier | MORS | DH | 1 d | 7 d | 14 d |
| 1 | V-TS (Formula I) | 0.060 | 20.3 | 6.0 | 14.5 | 21.0 |
| 2 | V*HS-His H (Ex. 16) | 0.060 | 12.8 | 7.4 | 16.8 | 24.7 |
| 3 | V*HS-His O (Ex. 29) | 0.059 | 7.1 | 8.8 | 17.3 | 28.0 |

The results in Table XXVIII show that the drier can also be synthesized from three components (aldehyde, histidine and a vanadium precursor in this case) directly in the formulation, and that the resulting formulation shows superior performance compared with the one made from the simple vanadium-drier V-TS and basically identical performance as a formulation made with the same drier, which was synthesized before mixing it with the resin (compare entries 1-3). In addition, the results also show that a good performance is achieved when the drier is synthesized from the two organic components without the addition of a base (compare Examples 16 and 29).

The best mode for carrying out the invention has been described for purposes of illustrating the best mode known to the applicant at the time. The examples are illustrative only and not meant to limit the invention, as measured by the scope and merit of the claims. The invention has been described with reference to preferred and alternate embodiments. Obviously, modifications and alterations will occur to others upon the reading and understanding of the specification. It is intended to include all such modifications and alterations insofar as they come within the scope of the appended claims or the equivalents thereof.

What is claimed is:

1. A process for improving at least one physical property of an oxidatively curable alkyd resin coating selected from the group consisting of improved resin hardness, reduced resin yellowing, reduced resin blistering, and reduced resin dry time, comprising the following steps in any order:
combining a metal source of vanadium, iron, manganese or copper with at least one non-symmetrical ligand with the provisos that:
(a) when the non-symmetrical ligand is of the type L_{O,N} or L_{O,N,O}, the non-symmetrical ligand comprises at least one of a terminal carboxylic acid group or a phenolic hydroxy group and at least one of a primary amine or Schiff base or pyridine nitrogen group; and wherein
(b) when the non-symmetrical ligand is of the type L_{O,N,O} comprising at least one terminal carboxylic acid, the non-symmetrical ligand comprises at least one phenolic hydroxy functional group in addition to the at least one terminal carboxylic acid group.

2. The process of claim 1 wherein the at least one non-symmetrical ligand comprises formula XXV or or formula XXVI or formula XXVII or formula XXVIII:
wherein Formula XXV is: 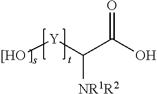
and wherein
R¹ and R² are independently selected from the group consisting of H, C₁₋₄ linear and branched alkyl;
Y is selected from the group consisting of
(a) linear and branched, substituted and unsubstituted C₁₋₁₀ alkyl wherein the substituents comprise amine, carbonyl and sulfhydryl groups,
(b) linear and branched, substituted and unsubstituted C₆₋₂₀ aryl wherein the substituents comprise heteroatoms, and further comprising N and O, and wherein the C₆₋₂₀ aryl further optionally comprise C₅₋₆ and C₅₋₅ and C₆₋₆ fused rings,
(c) linear and branched C₇₋₄₀ alkylaryl further comprising interposed heteroatoms selected from the group consisting of nitrogen and oxygen and sulfur atoms interspersed within the backbone chain or terminating the chain and further wherein the C₇₋₄₀ alkylaryl further optionally comprise C₅₋₆ and C₅₋₅ and C₆₋₆ fused rings;
(d) linear and branched, substituted and unsubstituted C₇₋₄₀ arylalkyl, further comprising heteroatoms, and further comprising nitrogen and oxygen and sulfur atoms interspersed within the backbone chain or terminating the chain and further wherein the C₇₋₄₀ arylalkyl further optionally comprise C₅₋₆ and C₅₋₅ and C₆₋₆ fused rings;
s is an integral value ranging from 0 and 1 inclusive;
t is an integral value ranging from 0 and 1 inclusive.
and wherein Formula XXVI is: 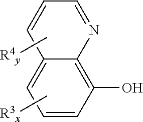
and wherein
R³ and R⁴ are selected from the group previously defined for Y in formula XXV;
x is an integral value ranging from 0 to 3;
y is an integral value ranging from 0 to 3;
and wherein Formula XXVII is: 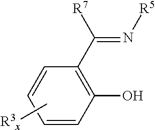
and wherein
R³ and x are as defined previously for Y Formula XXVI;
R⁵ and R⁷ are selected from the group previously defined for Y in formula XXV;
and wherein Formula XXVIII is: 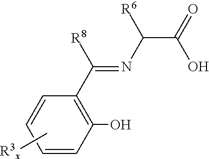
and wherein
R³ and x are as defined previously for Y for Formula XXVI; and
R⁶ and R⁸ are selected from the group previously defined for Y in formula XXV.

3. The process of claim 2 wherein the non-symmetrical ligand is selected from the group consisting of alanine, arginine, asparagine, aspartic acid, cysteine, glutamic acid, glutamine, glycine, histidine, hydroxyproline, isoleucine, leucine, lysine, methionine, phenylalanine, proline, pyroglutamatic acid, serine, threonine, tryptophan, tyrosine and valine.

4. The process of claim 2 wherein the non-symmetrical ligand is selected from amino-acid adducts of salen ligands, namely:
2-((2-hydroxybenzylidene)amino)-3-(1H-imidazol-4-yl)propanoic acid,
2-((2-hydroxybenzylidene)amino)-3-(1H-indol-3-yl)propanoic acid,
3-hydroxy-2-((2-hydroxybenzylidene)amino)propanoic acid,
2-((2-hydroxybenzylidene)amino)-4-(methylthio)butanoic acid,
2-((2-hydroxybenzylidene)amino)succinic acid,
2-((2-hydroxybenzylidene)amino)pentanedioic acid,
2-((2-hydroxybenzylidene)amino)acetic acid,
6-amino-2-((2-hydroxybenzylidene)amino)hexanoic acid,
2-((2-hydroxybenzylidene)amino)-3-(4-hydroxyphenyl)propanoic acid,
2-((2-hydroxybenzylidene)amino)-3-phenylpropanoic acid,
4-amino-2-((2-hydroxybenzylidene)amino)-4-oxobutanoic acid,
2-((2-hydroxybenzylidene)amino)-3-mercaptopropanoic acid,
3-((2-carboxy-2-((2-hydroxybenzylidene)amino)ethyl)disulfaneyl)-2-((2-hydroxybenzylidene)amino) propanoic acid,
5-guanidino-2-((2-hydroxybenzylidene)amino)pentanoic acid,
2-((2-hydroxybenzylidene)amino)-4-methylpentanoic acid,
1-(2-hydroxybenzylidene)pyrrolidin-1-ium-2-carboxylate, and
2-((1-(2-hydroxyphenyl)ethylidene)amino)-3-(1H-imidazol-4-yl)propanoic acid.

5. The process of claim 1 wherein a MORS value for the vanadium, iron, manganese or copper ranges from 0.001 to 1 wt. % inclusive.

6. The process of claim 1 wherein the ligand is added in any of the following combinations: premade with the metal, added before or after the metal to the resin or as a prepack system.

7. The process of claim 1 in which the non-symmetrical ligand is an amino acid selected from the group consisting of tryptophan, serine, arginine, methionine, leucine, proline, glycine, glutamine, lysine, tyrosine, phenalanine, asparagine, cysteine, cystine, and aspartic acid, alanine, isoleucine, threonine, valine and selenocysteine.

8. The process of claim 1 in which the ligand is a C₁-C₆ alkyl substituted non-symmetrical amino acid.

9. The process of claim 1, wherein the process further comprises:
the addition of BOC, namely iron(1+), chloro[dimethyl 9,9-dihydroxy-3-methyl-2,4-di(2-pyridinyl-kN)-7-[(2-pyridinyl-kN)methyl]-3,7-diazabicyclo[3.3.1]nonane-1,4-dicarboxylate-kN3,kN7]-, chloride(1:1) with said non-symmetrical amino acid ligand.

10. The process of claim 7 in which the ligand is at least two ligands or blends thereof.

11. The process of claim 1, wherein the process further comprises:
the addition of at least one additive selected from the group consisting of antiskinning agents, UV stabilisers, dispersants, surfactants, inhibitors, fillers, antistatic agents, flame-retardants, lubricants, antifoaming agents, antifouling agents, bactericides, fungicides, algaecides, insecticides, extenders, plasticisers, antifreezing agents, waxes, thickeners, inorganic or organic, transparent or non-transparent pigments, cosolvents, dispersants, surfactants, inhibitors, fillers, anti-static agents, flame-retardant agents, lubricants, anti-foaming agents, extenders, waxes, thickeners, thixotropic agents, anti-oxidants and anti-skinning agents.

12. The process of claim 1 wherein the metal source and the at least one non-symmetrical ligand are used in a solvent-based or water-borne paint.

13. The process of claim 1 wherein the metal source and at least one non-symmetrical ligand are used in an alkyd paint or an oxidatively curable ink.

14. The process of claim 1 wherein the metal source and at least one non-symmetrical ligand are used in a composite.

15. The process of claim 1 wherein the metal source and at least one non-symmetrical ligand are water-borne or solvent-borne.

16. An oxidatively curable alkyd resin composition comprising:
a metal source of vanadium, iron, manganese or copper; and
at least one non-symmetrical ligand,
wherein:
(a) when the non-symmetrical ligand is of the type L_{O,N} or L_{O,N,O}, the non-symmetrical ligand comprises at least one of a terminal carboxylic acid group or a phenolic hydroxy group and at least one of a primary amine or Schiff base or pyridine nitrogen group; and
(b) when the non-symmetrical ligand is of the type L_{O,N,O} comprising at least one terminal carboxylic acid, the non-symmetrical ligand comprises at least one phenolic hydroxy functional group in addition to the at least one terminal carboxylic acid group.

17. The oxidatively curable alkyd resin composition of claim 16, wherein the at least one non-symmetrical ligand comprises formula XXV or or formula XXVI or formula XXVII or formula XXVIII:
wherein Formula XXV is: 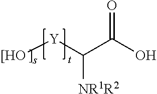
and wherein
R¹ and R² are independently selected from the group consisting of H, C₁-4 linear and branched alkyl;
Y is selected from the group consisting of
(a) linear and branched, substituted and unsubstituted C₁₋₁₀ alkyl wherein the substituents comprise amine, carbonyl and sulfhydryl groups,
(b) linear and branched, substituted and unsubstituted C₆₋₂₀ aryl wherein the substituents comprise heteroatoms, and further comprising N and O, and wherein the C₆₋₂₀ aryl further optionally comprise C₅₋₆ and C₅₋₅ and C₆₋₆ fused rings,
(c) linear and branched C₇₋₄₀ alkylaryl further comprising interposed heteroatoms selected from the group consisting of nitrogen and oxygen and sulfur atoms interspersed within the backbone chain or terminating the chain and further wherein the C₇₋₄₀ alkylaryl further optionally comprise C₅₋₆ and C₅₋₅ and C₆₋₆ fused rings;
(d) linear and branched, substituted and unsubstituted C₇₋₄₀ arylalkyl, further comprising heteroatoms, and further comprising nitrogen and oxygen and sulfur atoms interspersed within the backbone chain or terminating the chain and further wherein the C₇₋₄₀ arylalkyl further optionally comprise C₅₋₆ and C₅₋₅ and C₆₋₆ fused rings;
s is an integral value ranging from 0 and 1 inclusive;
t is an integral value ranging from 0 and 1 inclusive.
and wherein Formula XXVI is: 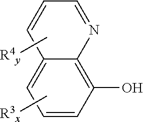
and wherein
R³ and R⁴ are selected from the group previously defined for Y in formula XXV;
x is an integral value ranging from 0 to 3;
y is an integral value ranging from 0 to 3;
and wherein Formula XXVII is: 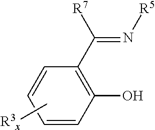
and wherein
R³ and x are as defined previously for Y Formula XXVI;
R⁵ and R⁷ are selected from the group previously defined for Y in formula XXV;
and wherein Formula XXVIII is: 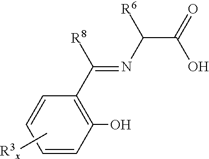
and wherein
R³ and x are as defined previously for Y for Formula XXVI; and
R⁶ and R⁸ are selected from the group previously defined for Y in formula XXV.

18. The oxidatively curable alkyd resin composition of claim 16, wherein the non-symmetrical ligand is selected from the group consisting of alanine, arginine, asparagine, aspartic acid, cysteine, glutamic acid, glutamine, glycine, histidine, hydroxyproline, isoleucine, leucine, lysine, methionine, phenylalanine, proline, pyroglutamatic acid, serine, threonine, tryptophan, tyrosine and valine.

19. The oxidatively curable alkyd resin composition of claim 16, wherein the at least one non-symmetrical ligand is selected from amino-acid adducts of salen ligands, namely:
2-((2-hydroxybenzylidene)amino)-3-(1H-imidazol-4-yl)propanoic acid,
2-((2-hydroxybenzylidene)amino)-3-(1H-indol-3-yl)propanoic acid,
3-hydroxy-2-((2-hydroxybenzylidene)amino)propanoic acid,
2-((2-hydroxybenzylidene)amino)-4-(methylthio)butanoic acid,
2-((2-hydroxybenzylidene)amino)succinic acid,
2-((2-hydroxybenzylidene)amino)pentanedioic acid,
2-((2-hydroxybenzylidene)amino)acetic acid,
6-amino-2-((2-hydroxybenzylidene)amino)hexanoic acid,
2-((2-hydroxybenzylidene)amino)-3-(4-hydroxyphenyl)propanoic acid,
2-((2-hydroxybenzylidene)amino)-3-phenylpropanoic acid,
4-amino-2-((2-hydroxybenzylidene)amino)-4-oxobutanoic acid,
2-((2-hydroxybenzylidene)amino)-3-mercaptopropanoic acid,
3-((2-carboxy-2-((2-hydroxybenzylidene)amino)ethyl)disulfaneyl)-2-((2-hydroxybenzylidene)amino)propanoic acid,
5-guanidino-2-((2-hydroxybenzylidene)amino)pentanoic acid,
2-((2-hydroxybenzylidene)amino)-4-methylpentanoic acid,
1-(2-hydroxybenzylidene)pyrrolidin-1-ium-2-carboxylate, and 2-((1-(2-hydroxyphenyl)ethylidene)amino)-3-(1H-imidazol-4-yl)propanoic acid.

20. The oxidatively curable alkyd resin composition of claim 16, wherein a MORS value for the vanadium, iron, manganese or copper in the oxidatively curable alkyd resin composition ranges from 0.001 to 1 wt. % inclusive.
